(19) United States
(12) Patent Application Publication
(10) Pub. No.: US 2015/0049063 A1
(43) Pub. Date: Feb. 19, 2015

(54) Touch Sensing Systems

(71) Applicant: Light Blue Optics Ltd, Cambridge (GB)

(72) Inventors: Euan Christopher Smith, Longstanton (GB); Paul Richard Routley, Cambridge (GB); Lilian Lacoste, Gan (FR)

(21) Appl. No.: 14/388,341

(22) PCT Filed: Mar. 25, 2013
(86) PCT No.: PCT/GB2013/050765

§ 371 Date: Sep. 26, 2014

(30) Foreign Application Priority Data
Mar. 26, 2012 (GB) 1205303.9

(51) Int. Cl. G06F 3/042

(52) U.S. Cl. CPC G06F 3/0421; G06F 3/0425; G06F 3/0426; G06F 2203/04106
USPC 345/175

(57) ABSTRACT

A touch sensing system, for sensing the position of at least one object with respect to surface, the system comprising: a first, 2D touch sensing subsystem to detect a first location of said object with respect to a surface and to provide first location data; a second, object position sensing subsystem to detect a second location of said object, wherein said second location of said object is not constrained by said surface, and to provide second location data; a system to associate said first location data and said second location and to determine additional object-related data from said association; and a system to report position data for said object, wherein said position data comprises data dependent on at least one of said first and second locations and on said additional object-related data.

### CROSS REFERENCE TO RELATED APPLICATION

This application claims priority to PCT Application No. PCT/GB2013/050765 entitled “Touch Sensing Systems” and filed Mar. 25, 2013; which claims priority to UK Application No. GB1205303.9 and filed Mar. 26, 2012. The entirety of the aforementioned applications is incorporated herein by reference for all purposes.

### FIELD OF THE INVENTION

This invention relates to improvements in touch sensing systems, in particular those of the type which project a sheet of light adjacent a projected image.

### BACKGROUND OF THE INVENTION

Background prior art relating to touch sensing systems employing a plane or sheet of light can be found in U.S. Pat. No. 6,281,878 (Montellese), and in various later patents of Lumio/VKB Inc, such as U.S. Pat. No. 7,305,368, as well as in similar patents held by Canesta Inc, for example U.S. Pat. No. 6,710,770. Broadly speaking these systems project a fan-shaped plane of infrared (IR) light just above a displayed image and use a camera to detect the light scattered from this plane by a finger or other object reaching through to approach or touch the displayed image.

Further background prior art can be found in: WO01/93006; U.S. Pat. No. 6,650,318; U.S. Pat. No. 7,305,368; U.S. Pat. No. 7,084,857; U.S. Pat. No. 7,268,692; U.S. Pat. No. 7,417,681; U.S. Pat. No. 7,242,388 (US2007/222760); US2007/019103; WO01/93006; WO01/93182; WO2008/038275; US2006/187199; U.S. Pat. No. 6,614,422; U.S. Pat. No. 6,710,770 (US2002021287); U.S. Pat. No. 7,593,593; U.S. Pat. No. 7,599,561; U.S. Pat. No. 7,519,223; U.S. Pat. No. 7,394,459; U.S. Pat. No. 6,611,921; U.S. Pat. No. D595,785; U.S. Pat. No. 6,690,357; U.S. Pat. No. 6,377,238; U.S. Pat. No. 5,767,842; WO2006/108443; WO2008/146098; U.S. Pat. No. 6,367,933 (WO00/21282); WO02/101443; U.S. Pat. No. 6,491,400; U.S. Pat. No. 7,379,619; US2004/0095315; U.S. Pat. No. 6,281,878; U.S. Pat. No. 6,031,519; GB2,343,023A; U.S. Pat. No. 4,384,201; DE 41 21 180A; and US2006/244720.

We have previously described techniques for improved touch sensitive holographic displays, for example in our earlier patent applications: WO2010/073024; WO2010/073045; and WO2010/073047.

The inventors have continued to develop and advance touch sensing techniques suitable for use with these and other image display systems. In particular we will describe techniques which enable additional functionality such as, for example, the ability to ‘write’ on a touch sensitive projected image with different coloured pens.

### SUMMARY OF THE INVENTION

According to a first aspect of the invention there is therefore provided a touch sensing system, for sensing the position of at least one object with respect to surface, the system comprising: a first, 2D touch sensing subsystem to detect a first location of said object with respect to a surface and to provide first location data; a second, object position sensing subsystem to detect a second location of said object, wherein said second location of said object is not constrained by said surface, and to provide second location data; a system to associate said first location data and said second location and to determine additional object-related data from said association; and a system to report position data for said object, wherein said position data comprises data dependent on at least one of said first and second locations and on said additional object-related data.

Broadly speaking, embodiments of the touch sensing system employ sensor fusion to determine additional object-related data, in particular data defining a physical feature of an object such as a color of the object or some other physical feature relating to the appearance of the object for example pattern, shape, size, texture and the like. Thus in embodiments the reported position data, as well as defining a detected object's position, includes additional data identifying the object, more particularly a characteristic of the object such as whether or not the is identified as a finger, and/or its color, and the like.

In some cases, the color of the object maps to a color of a displayed indicator or a response to the touch on a projected image in a system including an image projector to project a displayed image. Thus, for example, multiple pens of different colors may be provided to ‘write’ in different colors on a touch sensitive projected display (although in principle color could be determined by some other object property such as shape).

Additionally or alternatively, the object-related data may relate to one or more other properties of an object such as an object pattern, shape, size, texture and the like. Thus, for example, an eraser may be identified by its size and/or shape and/or color marking.

Further additionally or alternatively the object-related data may relate to an associated property of the object, such as an identifier of a person holding the object, or an identifier of the object itself—for example where the object has an identifier such as a barcode or some other distinguishing feature more simply a variable size mark.

Still further additionally or alternatively the object-related may include data such as orientation data which may be useful, for example, for calligraphy.

In some embodiments the object is a passive object but, potentially, the object may itself emit a signal detected by the second, object position sensing subsystem.

As described further later, the object may include one or more user configurable or controllable features to provide one more user controls for a passive object: for example a user control may control a visual feature of an object such as a pen to change the appearance of the pen, for example by covering a feature, revealing a feature, moving or changing a feature, reversing the orientation of the pen, or in some other way. This modification of the passive object may then be employed to detect operation of the user control and thus provide, for example, one or more click-buttons at little or no additional hardware cost.

Broadly speaking in embodiments the location of an object determined by the 2D touch sensing subsystem—in embodiments a sheet of light based system—and the second object position sensing subsystem in embodiments a visual camera viewing the region above the displayed image—are linked to link the additional object-related data to the 2D touch sensing subsystem sensed position. Thus, broadly speaking, the information from the second sensing subsystem maps to the touch sensing subsystem. This mapping need not be exact and may, for example, be based upon probability or a density distribution for an object or suspected object located by the second sensing subsystem which may then be associated with the touch sensing subsystem.

As described further later, one or both sensing systems may track an object within the field of view. This can have particular advantages in the case of a 2D sheet of light touch sensing subsystem because it enables an object to be tracked in the spatial volume above the sheet of light. This can be used to determine, when an object disappears and reappears within the sheet of light, whether the object is the same or different to that previously identified in the 2D sheet. Furthermore such an approach facilitates implementation of a multi-touch system, in particular by disambiguating touches of different hands or different people—since in such cases the observed multiple-touches in the 2D sheet are linked in the spatial volume viewed by the second sensing subsystem.

Embodiments of the above described touch sensing system may be employed to link, say, a physical appearance of an object with an effect in a displayed image. However, as well, or instead of, this the additional object-related data may be employed to improve the operation of a 2D sensing subsystem, in particular by facilitating tracking of an object through a cone of occlusion: with a sheet-of-light touch sensing subsystem, an object closer to the source of the fan of light has a cone shaped-shadow behind which objects cannot be seen (as well as occlusion where one object or a hand obscures another). As we have previously described (our GB1200963.5 filed on 20 Jan. 2012) multiple overlapping fans can be used to ameliorate this problem, optionally in combination with object tracking techniques such as those described in our earlier application GB1110156.5 filed on 16 Jun. 2011—incorporated by reference. Nonetheless the presence of an additional sensing system can also significantly contribute to addressing the occlusion problem, by using the information from the second sensing subsystem to weight, filter or otherwise process data from the first 2D touch sensing subsystem.

In embodiments the position or accuracy of the information from the second sensing subsystem may be relatively low, but nonetheless it can be very useful to know whether or not the object is still present within the cone of occlusion, even where the positional information of the object from the second sensing subsystem is not used to track the object within the cone of occlusion. Thus the positional information may be derived from the 2D touch sensing subsystem by extrapolating from previous position/velocity information, for example using a Kalman filter, as previously described in our GB'156.5, ibid. Alternatively the generally coarser position information from the second sensing subsystem may be combined with the more accurate information from the 2D touch sensing subsystem. This may employ a weighted combination technique, or more generally use the coarser position information to refine the more accurate (predicted) 2D position information, for example, using a maximum likelihood estimator, α-β filter, or optical flow or other techniques.

In still other approaches, embodiments of the above described aspect of the invention may be employed to add gesture recognition to a touch sensing system. For example the system may identify when the second sensing subsystem detects movement of the object at the same time as the 2D touch sensing subsystem not detecting a touch of the projected image: thus a gesture within the system may be identified as a combination of a moving object and no-touch. Then the captured image from the second sensing subsystem may be applied to any of a range of gesture-detection engines to process the image to determine whether or not a gesture is in fact present, and to identify the gesture.

Then in still further implementations of the system, rather than use the second sensing subsystem to detect object-related data for the object detected by the touch sensing subsystem, the second object's position sensing subsystem may determine object-related data for a second, different object at the second location. A property of this second object may then be linked to that of the object at the first location detected by the touch sensing subsystem. In this way, for example, the touch sensing system may be employed to sense a user touching, picking up and/or manipulating an object, more particularly a physical object, at another location with respect to the touch surface. This may be used to modify the representation of a projected image at the first location. In this way, by way of an example, a physical magnetic chess piece may be attached to a display/touch surface, picked up and manipulated, the system second object identification then providing data to allow a software application to manipulate a representation of the object in the projected image. In another example the second sensing subsystem may be used to capture or scan an image of a second object (in some cases, a relatively large second object such as a poster). Alternatively some other manipulation of a physical second object placed on the touch sensitive display maybe provided to, in effect, map the physical second object to an image of the object within the displayed image (which may be a representation of the object or some other image).

In some particular embodiments the second sensing subsystem may be a relatively low accuracy position sensing system as compared with the touch accuracy provided by the 2D touch sensing subsystem. This provides a number of advantages including reduced system cost, reduced computational load and the like. Thus, in some embodiments the positional accuracy or resolution of the second sensing subsystem is less than that of the touch sensing subsystem at a point on a touch surface, in at least one direction within the touch surface. (Here the reference to ‘accuracy’ refers to the second location data provided by the second object position sensing subsystem that is optionally after centroid location or other processing).

In some embodiments the 2D touch sensing subsystem comprises a sheet of light based touch sensing subsystem but the skilled person will appreciate that the touch surface need not be a flat 2D surface. Similarly although in some embodiments the touch surface is adjacent to (just above) a displayed image, the touch surface need not be in this position and may, for example, comprise a surface or plane in midair.

The skilled person will also appreciate that the techniques we describe may be employed with other types of 2D touch sensing technology than light-sheet based sensing including, but not limited to: capacitive touch sensing, resistive touch sensing, bezel-based optical touch sensing, surface acoustic wave-based-touch sensing and so forth. The detected object will generally be proximate to or intersecting the touch surface; and the first location will generally define a lateral location on the surface.

In some embodiments the second, object position sensing subsystem comprises a visible light camera. The skilled person will appreciate that in various embodiments the visual camera captures a 2D image of the 3D space above the display surface—a 3D imaging camera is not needed (although though may be used if desired). The skilled person will also appreciate that in principle other types of second sensing subsystem may be employed, for example an ultrasonic sensing system or for an ‘active’, emitting object, a sensing system which detects a signal from the object and uses, say time of flight and/or triangulation to locate the object, optionally in 3D (for example using light or sound). In a still further alternative, the second sensing subsystem may comprise an IR (infra-red) camera.

Although in embodiments the 2D touch sensing subsystem employs an IR sheet of light and an IR-sensing camera, the touch sensing subsystem and second sensing subsystem may employ different IR wavelengths, for example by providing a narrow-band IR attenuation filter for the second sensing subsystem at a wavelength of the sheet of light of the touch sensing subsystem. With such an approach an object may be coded with an invisible code, for example a barcode or ‘multicolor’ IR barcode.

In embodiments the IR used by the touch sensing subsystem may be incorporated into the image projector. Where an IR camera is used for the second sensing subsystem this to maybe incorporated into the image projector, for example by employing one or more dichroic beam splitters and/or notch IR pass/reject filters in the optical path of the projector output optics. Alternatively the second object position sensing subsystem may comprise a visible light camera which has a mechanical, for example magnetic, attachment so that it can be straightforwardly clipped to the image projector, for example a digital light processor projector, which facilitates retro-fitting the touch sensing subsystem to an existing projector. In embodiments both the 2D touch sensing subsystem and second object positions sensing system may be mechanically, for example magnetically attached to the image projector in this manner, optionally adjacent a fiducial reference point on the projector, matching this with a corresponding fiducial reference point on the or each sensing system, to facilitate alignment in calibration.

In a still further approach irrespective of the wavelengths employed for the touch sensing subsystem and second sensing subsystem, the frame rates of cameras of these systems may be synchronized and the frame capture interleaved or otherwise arranged so that the second sensing subsystem provides captured image frames between captured frames of the touch sensing subsystem. These may then be used to increase positional accuracy by interpolation between touch sensing subsystem frames—although since the second sensing subsystem generally has a lower accuracy this information may be combined with that from the touch sensing subsystem in a maximum likelihood estimator, Kalman filter or the like, to augment the positional accuracy of the 2D touch sensing subsystem at positions intermediate between image frames of a camera of the 2D touch sensing subsystem.

In some one or more embodiments of the system the 2D touch sensing subsystem includes a tracking system (software) to track the locations of one or more objects. In such a case, in embodiments the object property data may be captured at, say, an initial touch by an object identified as a ‘new’ object in the touch sheet, linked or assigned to the new object, and then the object in association with its property data may subsequently be tracked by the tracking system of the touch sensing subsystem. This removes the need to continuously identify object property data, although it may still be advantageous to update the object property data at intervals to provide a ‘reset’. Similarly, the second sensing subsystem may advantageously be employed to connect touch locations in the 2D sheet, for example by image processing to identify connected regions within an image captured by the second object position sensing subsystem. This may identify isolated touch locations within the 2D sheet corresponding to a common connected region within the image from a second sensing subsystem as belonging to, for example, fingers on the same hand, arms on the same body or the like. The skilled person will appreciate that there are many techniques which may be employed to determine whether or not a region within a captured image from the second sensing subsystem is connected.

A similar technique may be used in either a single-touch or multi-touch system to determine when an object is removed from the touch sheet, thus becoming invisible to the 2D touch sensing subsystem, and then the same object is later replaced on the touch sheet. This may employ a similar technique to track a connected region from the second sensing subsystem camera over time: a point within the 2D sheet which, at different times, connects to a common shape which continues to exist in the images from the second sensing subsystem may be determined to be the same object, removed from and replaced onto the touch sheet.

Since embodiments of the system are able to distinguish between different objects, this may be employed to provide an action determination system. Thus in embodiments one object such as a pen, may be identified by the second sensing subsystem, and then the positions of one or more additional touches in the vicinity of the identified object may be employed to provide a virtual click-button or the like. Thus, for example, a finger-touch to one side of a pen may correspond to a ‘click’—and this concept may be extended to detect or distinguish between touches over a range of angular positions around the first object and/or at a range of different distances. In embodiments the actions need not be simultaneous and a user action maybe identified even when the second touch is after some delay following the first. Although in principle this technique may be employed without being able to distinguish between objects, the ability to distinguish between objects is advantageous because it allows the fiducial object, for example a pen, to be distinguished from the ‘secondary’ touches around the object. Such techniques maybe employed, for example, to pick up a virtual object (the touch sensing system linking to and modifying the displayed image). In a variant of these approaches, an action may be implemented by a lift-off rather than a touch-down touch action.

Embodiments of the touch sensing system may be coupled to an image projection system (either directly or via a common processor/computer), in particular to provide touch and object-related data to the image projection system, and/or to receive image-related data from the image projection system. Thus, for example, the projected image may potentially result in false positive signals from the second sensing subsystem where, say, a red projected image region is confused with a red pen touching the surface. This can be addressed by using the data from the image projector to attenuate a response of the second sensing subsystem to reduce distraction by the projected image, for example in a simple embodiment suppressing detection of an object where the color or shape of the object match an element in the projected image. In a similar approach red/green/blue sub-frame data may be employed, for example to determine an overall level of illumination at a particular color, to then compensate for this in the second object position sensing subsystem. This compensation may comprise, for example, reducing the sensitivity and/or blanking the output of the system when greater than the threshold level of illumination at a relevant color is identified. In a variant of this approach the image data provided by the projection system may comprise timing data indicating timing of the red/green/blue sub-frames. In this approach detection of one color may be synchronized to a time when that color is not being displayed, for example detecting red during a blue projection sub-frame and so forth.

In principle the object may simply comprise a portion of the user's finger or hand. Further it has been found experimentally that skin colors are sufficiently different between different individuals that this information may be used to distinguish between touches in different locations from different people. Thus the object color may comprise natural skin color of, say, a finger, and this may either be employed to control a color of a displayed response in the image and/or this may be employed to distinguish between, say, multiple different individuals using the touch sensing system at the same time.

Additionally or alternatively, as previously mentioned, the object may be a more sophisticated passive object such as a passive pen incorporating user controls which change the appearance of object by for example, moving an aperture. This may be employed to hide one or another spot or to change a spot count on the object, or to change a number of lines or line slope or orientation, or to modify the object appearance in some other way. Thus a user control on the object may comprise one or more buttons mechanically modifying an aspect of visual appearance of the objects or pen to implement one or more user buttons. Operation of these virtual ‘user buttons’ maybe detected by the second sensing subsystem and then provided as an output of from the system for use in any desirable manner.

Broadly speaking, therefore, the skilled person will appreciate that embodiments of the system enhance a 2D light-sheet based touch sensing subsystem to provide additional information relating to the touch object, for example identifying the object and/or when aware the touch occurs, tracking the object, providing additional information about the object and, in general, identifying objects and their actions.

Thus in a related aspect the invention provides a touch sensitive image display device, the device comprising: an image projector to project a displayed image onto a surface; a touch sensor optical system to project light defining a touch sheet above said displayed image; a first camera directed to capture a touch sense image from a region including at least a portion of said touch sheet, said touch sense image comprising light scattered from said touch sheet by an object approaching said displayed image; and a signal processor coupled to said first camera, to process a said touch sense image from said first camera to identify a location of said object relative to said displayed image; further comprising a second camera, having an overlapping field-of-view with said first camera; and wherein said signal process is further configured to combine image data from said first and second camera to identify additional object-related data for said object.

As previously mentioned, in some implementations the object-related data comprises color data for the object. Additionally or alternatively the signal processing maybe employed to improve tracking of a plurality of objects or fingers of one or more people.

In some embodiments the signal processing code processing the data from the object position sensing camera determines a position of one or more objects in an image space of this camera. The data may be filtered—for example holding a pen may result in two ‘blobs’ within the second camera image which may be merged, or one may be attenuated in favor of the other.

In embodiments this signal processing identifies an edge of an object region in the second camera image, in embodiments a top edge—this has been found in practice to give a more useful positional accuracy than the determining the centroid of a region in the second camera image (despite the in principle lower resolution of the edge-detection approach, which is limited to the granularity of the pixel resolution). Thus embodiments of the signal processing detect an uppermost edge of the detected image from the second camera to identify the location of the object in the second camera image. (Here ‘uppermost’ refers to the maximum excursion of the regional object in one direction within the image, optionally after filtering, noise reduction and the like).

In a related aspect the invention provides a method of touch sensing in a touch sensitive image display device, the method comprising: projecting a displayed image onto a surface; projecting a light defining a touch sheet above said displayed image; capturing a touch sense image from a region including at least a portion of said touch sheet, said touch sense image comprising light scattered from said touch sheet by an object approaching said displayed image; and processing said touch sense image to identify a location of said object relative to said displayed image; the method further comprising: capturing a second, image from a region above said displayed image; and using data from said second image to provide additional object-related data for said object.

The invention further provides a method of calibrating a system as described above, the method comprising: projecting calibration pattern; capturing images from said touch sensing subsystem and said second object position sensing subsystem/camera; and determining respective spatial distortion-correcting calibrations for said touch sensing subsystem and said second object position subsensing system/camera from the same said calibration pattern.

In some cases, it may be desirable to employ a common pattern or grid to calibrate both the first and second cameras simultaneously (2D touch subsystem and second sensing subsystem), as this effectively compensates for a different keystone, barrel and other distortions within the images, facilitating later merging and linked processing of the captured image data from the two cameras. In embodiments the distortions may be represented by a third degree polynomial correction which is applied to the image position data and/or, to the image pixels prior to subsequent processing.

The invention still further provides a method of capturing a user action in a system as described above, the method comprising: identifying a first touch with a first object at a first location; distinguishing a second touch with a second, different object at a second different location; and determining a user action dependent on one or both of a distance and a direction of said second touch with reference to said first touch.

The invention still further provides a physical, non-transitory data carrier carrying processor control code to implement a method as described above. The carrier may be, for example, a disk, CD- or DVD-ROM, or programmed memory such as read-only memory (Firmware). The code (and/or data) may comprise source, object or executable code in a conventional programming language (interpreted or compiled) such as C, or assembly code, for example for general purpose computer system or a digital signal processor (DSP), or the code may comprise code for setting up or controlling an ASIC (Application Specific Integrated Circuit) or FPGA (Field Programmable Gate Array), or code for a hardware description language. As the skilled person will appreciate such code and/or data may be distributed between a plurality of coupled components in communication with one another.

Embodiments of each of the above described aspects of the invention may be used in a range of touch-sensing display applications. However embodiments the invention are particularly useful for large area touch coverage, for example in interactive whiteboard or similar applications.

Embodiments of each of the above described aspects of the invention are not limited to use with any particular type of projection technology. Thus although we will describe later an example of a holographic image projector, the techniques of the invention may also be applied to other forms of projection technology including, but not limited to, digital micro mirror-based projectors such as projectors based on DLP™ (Digital Light Processing) technology from Texas Instruments, Inc., projectors based on LCD (Liquid Crystal Display) technology, or projectors based on LCOS (Liquid Crystal On Silicon) technology.

### BRIEF DESCRIPTION OF THE DRAWINGS

These and other aspects of the invention will now be further described, by way of example only, with reference to the accompanying figures in which:

FIGS. 1a and 1b show, respectively, a vertical cross section view through an example touch sensitive image display device, and details of a sheet of light-based touch sensing system for the device;

FIG. 2 shows a functional block diagram of an image projection system for use with the device of FIG. 1;

FIGS. 3a to 3e show, respectively, an embodiment of a touch sensitive image display device according to an aspect of the invention, use of a crude peak locator to find finger centroids, and the resulting finger locations;

FIGS. 4a and 4b show, respectively, a plan view and a side view of an interactive whiteboard incorporating a touch sensitive image display with a calibration system;

FIGS. 5a to 5d show, respectively, a shared optical configuration for a touch sensitive image display device, an alternative shared optical configuration for the device, a schematic illustration of an example of a spatially patterned filter for use in embodiments of the device, and details of a calibration signal processing and control system for the device;

FIGS. 6a to 6c show, respectively, first, second and third examples of multi-touch touch sensitive image display devices;

FIGS. 7a and 7b show a touch sensing system according to an embodiment of the invention;

FIGS. 8a to 8g show, respectively, schematic captured and processed visual images, schematic capture and processed touch images, actual example visual and touch images, a flow diagram of an example visual image processing procedure according to an embodiment of the invention;

FIG. 9 shows an embodiment of a combined visual/IR object/touch image processing procedure according to an embodiment of the invention; and

FIGS. 10a to 10d show example image projection/touch sensing optics/systems according to embodiments of the invention.

### DETAILED DESCRIPTION

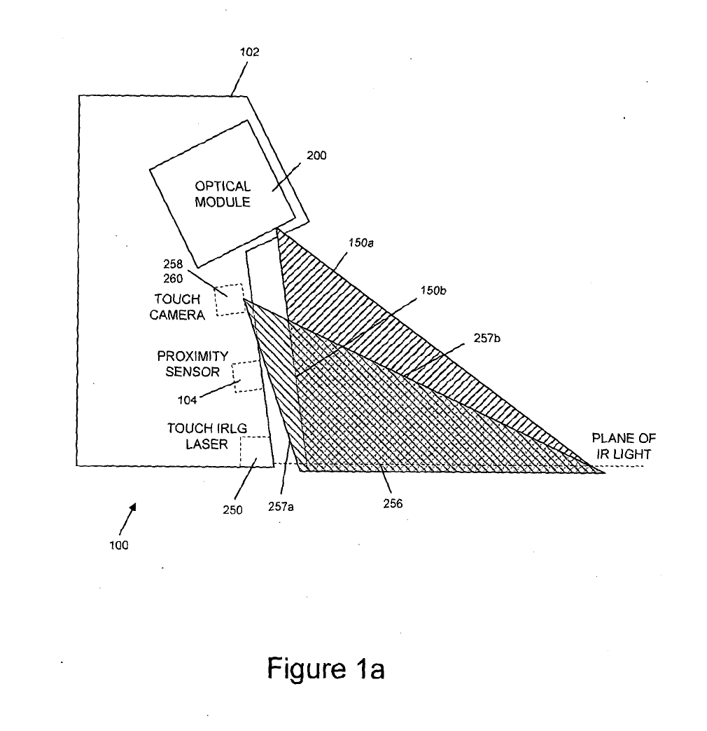

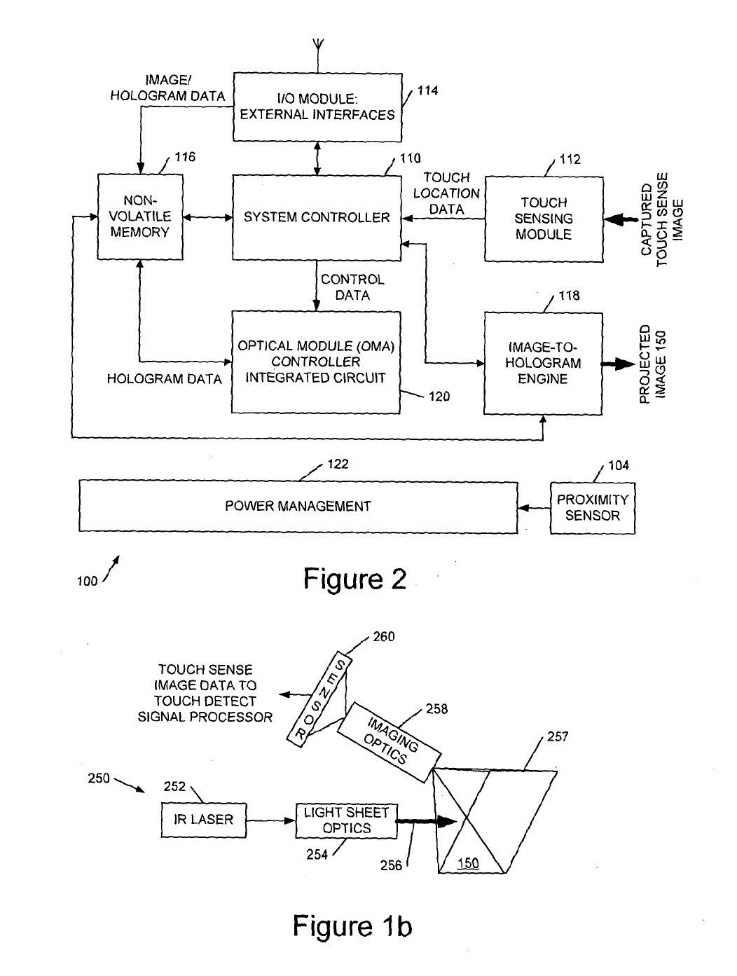

FIGS. 1a and 1b show an example touch sensitive image projection device 100 comprising an image projection module 200 and a touch sensing system 250, 258, 260 in a housing 102. A proximity sensor 104 may be employed to selectively power-up the device on detection of proximity of a user to the device.

The image projection module 200 is configured to project downwards and outwards onto a flat surface such as a tabletop. This entails projecting at an acute angle onto the display surface (the angle between a line joining the center of the output of the projection optics and the middle of the displayed image and a line in a plane of the displayed image is less than 90°). We sometimes refer to projection onto a horizontal surface, conveniently but not essentially non-orthogonally, as “table down projection”. A holographic image projector can be useful in this “table down” application because it can provide a wide throw angle, long depth of field, and substantial distortion correction without significant loss of brightness/efficiency. Boundaries of the light forming the displayed image 150 are indicated by lines 150a, b.

The touch sensing system 250, 258, 260 comprises an infrared laser illumination system (IR line generator) 250 configured to project a sheet of infrared light 256 just above, for example ˜1 mm above, the surface of the displayed image 150 (although in principle the displayed image could be distant from the touch sensing surface). The laser illumination system 250 may comprise an IR LED or laser 252, in some cases collimated, then expanded in one direction by light sheet optics 254, which may comprise a negative or cylindrical lens. Optionally light sheet optics 254 may include a 45 degree mirror adjacent the base of the housing 102 to fold the optical path to facilitate locating the plane of light just above the displayed image.

A CMOS imaging sensor (touch camera) 260 is provided with an IR-pass lens 258 captures light scattered by touching the displayed image 150, with an object such as a finger, through the sheet of infrared light 256. The boundaries of the CMOS imaging sensor field of view are indicated by lines 257, 257a, b. The touch camera 260 provides an output to touch detect signal processing circuitry as described further later.

An example holographic image projection system is described on our WO2010/007404. However a holographic image projector is merely an example; the techniques we describe later may be employed with any type of image projection system, in particular, for example, DLP-based image projection systems.

FIG. 2 shows a clock diagram of an example of the device 100 of FIG. 1 including an image projection system, which may be a holographic projector. A system controller 110 is coupled to a touch sensing module 112 from which it receives data defining one or more touched locations on the display area, either in rectangular or in distorted coordinates (in the latter case the system controller may perform keystone distortion compensation). The touch sensing module 112 in embodiments comprises a CMOS sensor driver and touch-detect processing circuitry.

The system controller 110 is also coupled to an input/output module 114 which provides a plurality of external interfaces, in particular for buttons, LEDs, optionally a USB and/or Bluetooth (RTM) interface, and a bi-directional wireless communication interface, for example using WiFi (RTM). In embodiments the wireless interface may be employed to download data for display either in the form of images or in the form of hologram data. In an ordering/payment system this data may include price data for price updates, and the interface may provide a backhaul link for placing orders, handshaking to enable payment and the like. Non-volatile memory 116, for example Flash RAM is provided to store data for display, including hologram data, as well as distortion compensation data, and touch sensing control data (identifying regions and associated actions/links). Non-volatile memory 116 is coupled to the system controller and to the I/O module 114, as well as to an optional image-to-hologram engine 118 as previously described (also coupled to system controller 110), and to an optical module controller 120 for controlling the optics shown in FIG. 2a. (The image-to-hologram engine is optional as the device may receive hologram data for display from an external source). In embodiments the optical module controller 120 receives hologram data for display and drives the hologram display SLM (optionally as well as controlling the laser output powers—for more details see, for example, our WO2008/075096). Various embodiments of the device also include a power management system 122 to control battery charging, monitor power consumption, invoke a sleep mode and the like.

In operation the system controller controls loading of the image/hologram data into the non-volatile memory, where necessary conversion of image data to hologram data, and loading of the hologram data into the optical module and control of the laser intensities. The system controller also performs distortion compensation and controls which image to display when and how the device responds to different “key” presses and includes software to keep track of a state of the device. The controller is also configured to transition between states (images) on detection of touch events with coordinates in the correct range, a detected touch triggering an event such as a display of another image and hence a transition to another state. The system controller 110 also, in embodiments, manages price updates of displayed menu items, and optionally payment, and the like.

### Touch Sensing Systems

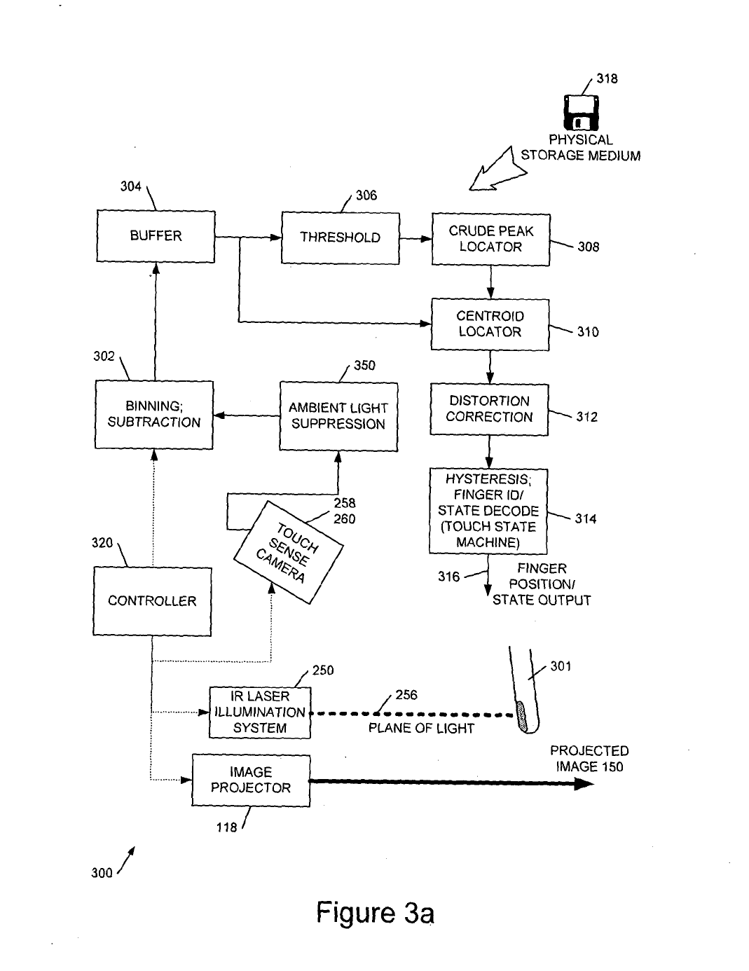

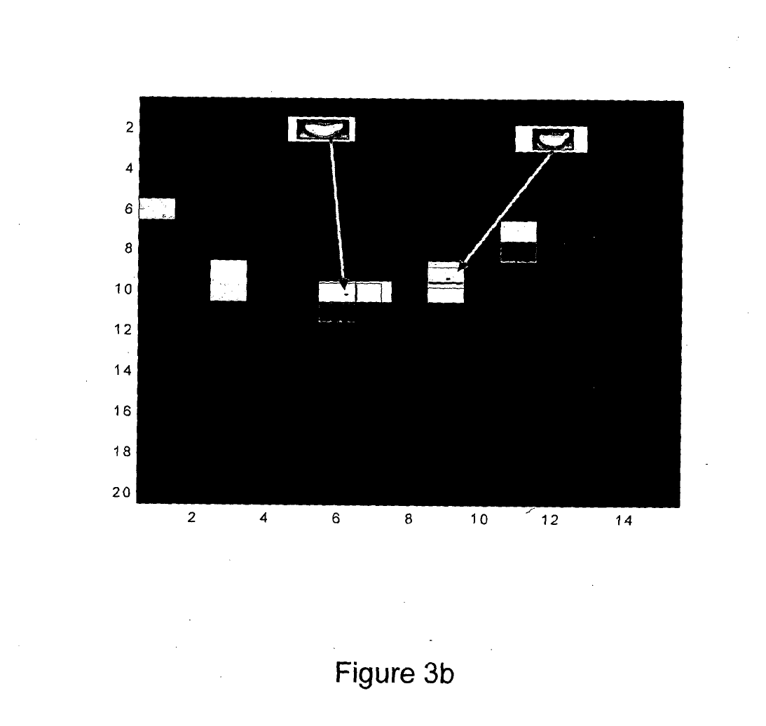

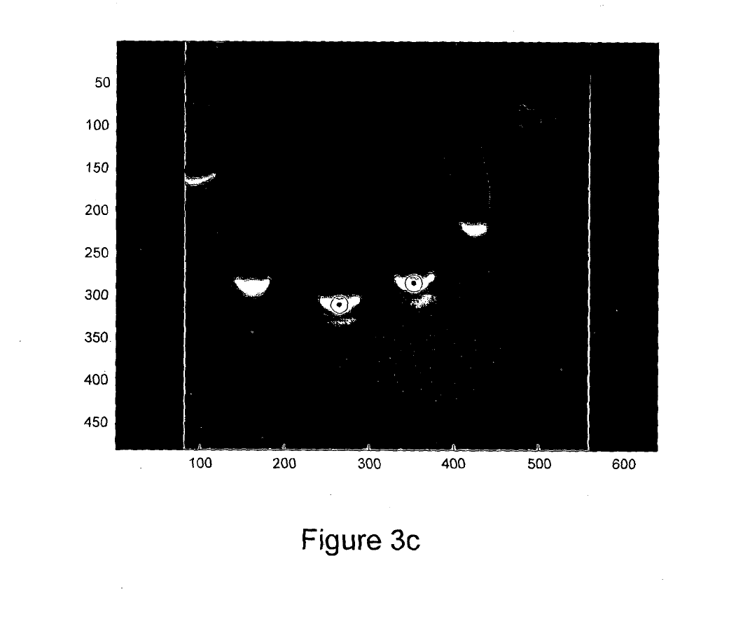

Referring now to FIG. 3a, this shows an embodiment of a touch sensitive image display device 300 according to an aspect of the invention. The system comprises an infra-red laser and optics 250 to generate a plane of light 256 viewed by a touch sense camera 258, 260 as previously described, the camera capturing the scattered light from one or more fingers 301 or other objects interacting with the plane of light. The system also includes an image projector 118, for example a holographic image projector, also as previously described, to project an image typically generally in front of the device, in embodiments generally downwards at an acute angle to a display surface.

In the arrangement of FIG. 3a a controller 320 controls the IR laser on and off, controls the acquisition of images by camera 260 and controls projector 118. In the illustrated example images are captured with the IR laser on and off in alternate frames and touch detection is then performed on the difference of these frames to subtract out any ambient infra-red. The image capture objects 258 may also include a notch filter at the laser wavelength which may be around 780-950 nm. Because of laser diodes process variations and change of wavelength with temperature this notch may be relatively wide, for example of order 20 nm and thus it is desirable to suppress ambient IR. In the embodiment of FIG. 3a subtraction is performed by module 302 which, in embodiments, is implemented in hardware (an FPGA).

In embodiments module 302 also performs binning of the camera pixels, for example down to approximately 80 by 50 pixels. This helps reduce the subsequent processing power/memory requirements and is described in more detail later. However such binning is optional, depending upon the processing power available, and even where processing power/memory is limited there are other options, as described further later. Following the binning and subtraction the captured image data is loaded into a buffer 304 for subsequent processing to identify the position of a finger or, in a multi-touch system, fingers.

Because the camera 260 is directed down towards the plane of light at an angle it can be desirable to provide a greater exposure time for portions of the captured image further from the device than for those nearer the device. This can be achieved, for example, with a rolling shutter device, under control of controller 320 setting appropriate camera registers.

Depending upon the processing of the captured touch sense images and/or the brightness of the laser illumination system, differencing alternate frames may not be necessary (for example, where ‘finger shape’ is detected). However where subtraction takes place the camera should have a gamma of substantial unity so that subtraction is performed with a linear signal.

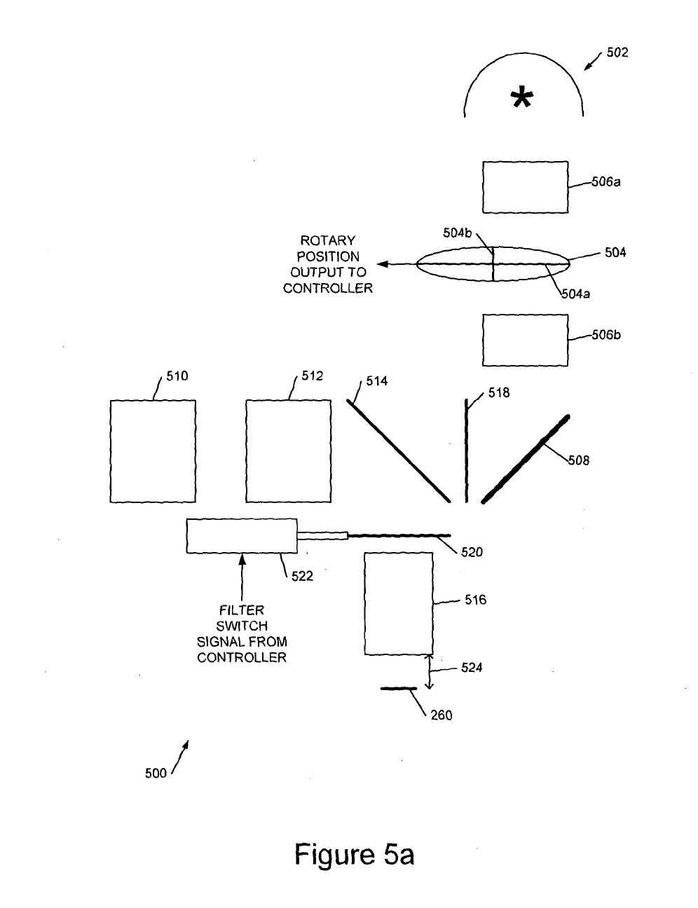

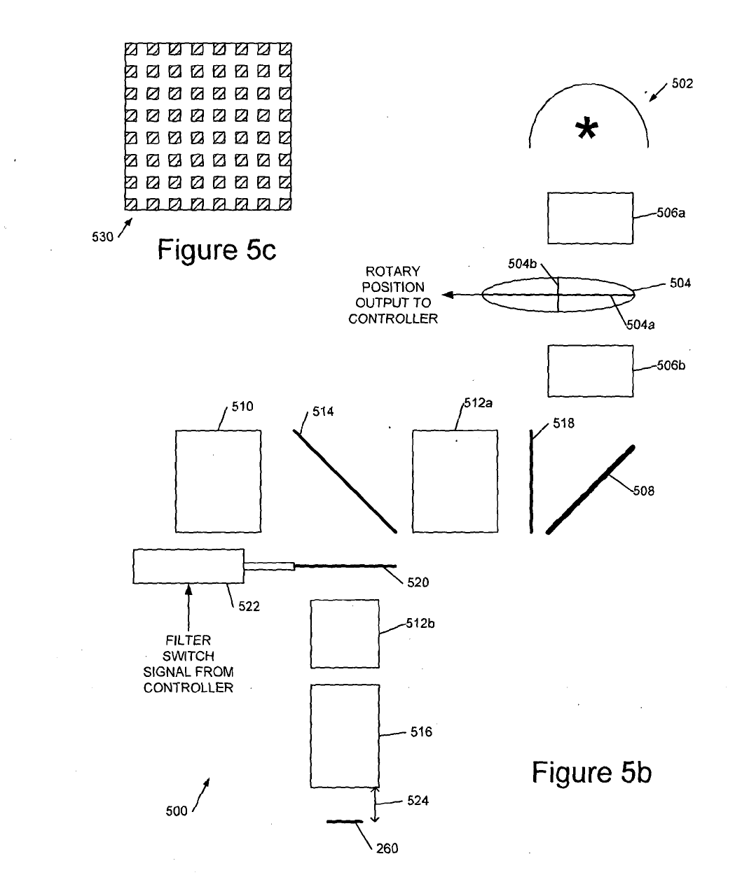

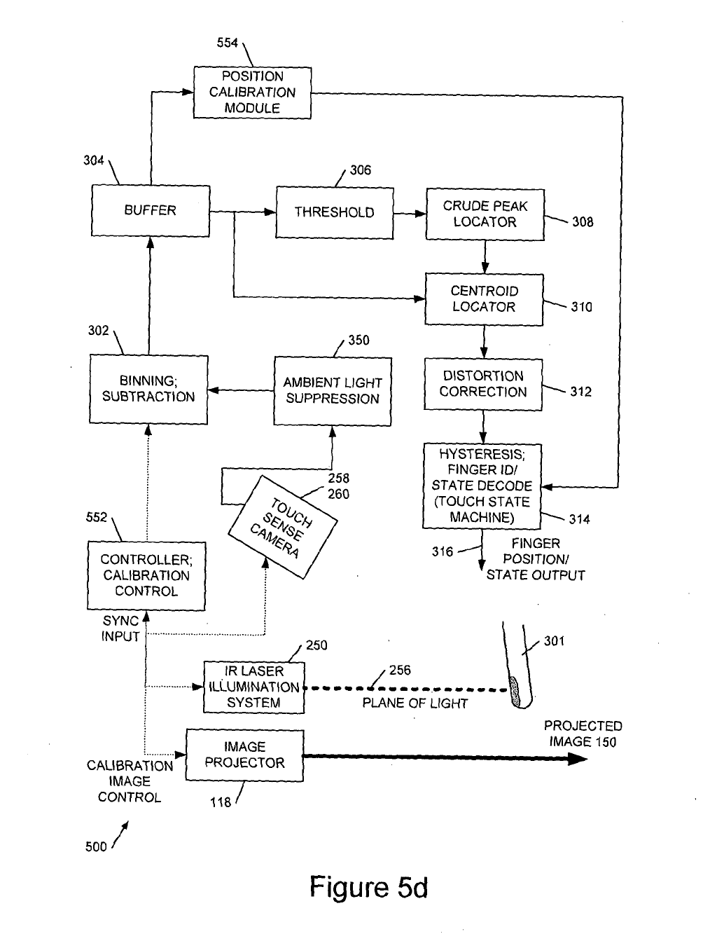

Various different techniques for locating candidate finger/object touch positions will be described. In the illustrated example, however, an approach is employed which detects intensity peaks in the image and then employs a centroid finder to locate candidate finger positions. In embodiments this is performed in software. Processor control code and/or data to implement the aforementioned FPGA and/or software modules shown in FIG. 3 (and also to implement the modules described later with reference to FIG. 5) may be provided on a disk 318 or another physical storage medium.

Thus in embodiment's module 306 performs thresholding on a captured image and, in embodiments, this is also employed for image clipping or cropping to define a touch sensitive region. Optionally some image scaling may also be performed in this module. Then a crude peak locator 308 is applied to the thresholded image to identify, approximately, regions in which a finger/object is potentially present.

FIG. 3b illustrates an example such a coarse (decimated) grid. In the Figure the spots indicate the first estimation of the center-of-mass. We then take a 32×20 (say) grid around each of these. This is used in conjunction with a differential approach to minimize noise, i.e. one frame laser on, next laser off.

A centroid locator 310 (center of mass algorithm) is applied to the original (unthresholded) image in buffer 304 at each located peak, to determine a respective candidate finger/object location. FIG. 3c shows the results of the fine-grid position estimation, the spots indicating the finger locations found.

The system then applies distortion correction 312 to compensate for keystone distortion of the captured touch sense image and also, optionally, any distortion such as barrel distortion, from the lens of imaging optics 258. In one embodiment the optical access of camera 260 is directed downwards at an angle of approximately 70° to the plane of the image and thus the keystone distortion is relatively small, but still significant enough for distortion correction to be desirable.

Because nearer parts of a captured touch sense image may be brighter than further parts, the thresholding may be position sensitive (at a higher level for minor image parts) alternatively position-sensitive scaling may be applied to the image in buffer 304 and a substantially uniform threshold may be applied.

In one embodiment of the crude peak locator 308 the procedure finds a connected region of the captured image by identifying the brightest block within a region (or a block with greater than a threshold brightness), and then locates the next brightest block, and so forth, in some cases up to a distance limit (to avoid accidentally performing a flood fill). Centroid location is then performed on a connected region. In embodiments the pixel brightness/intensity values are not squared before the centroid location, to reduce the sensitivity of this technique to noise, interference and the like (which can cause movement of a detected centroid location by more than once pixel).

A simple center-of-mass calculation is sufficient for the purpose of finding a centroid in a given ROI (region of interest), and R(x,y) may be estimated thus:

$$x = \frac{{\sum }_{{y}_{S} = 0}^{Y - 1} {\sum }_{{x}_{S} = 0}^{X - 1} {x}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

$$y = \frac{{\sum }_{{y}_{S} = 0}^{Y - 1} {\sum }_{{x}_{S} = 0}^{X - 1} {y}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

where n is the order of the CoM calculation, and X and Y are the sizes of the ROI.

In embodiments the distortion correction module 312 performs a distortion correction using a polynomial to map between the touch sense camera space and the displayed image space: Say the transformed coordinates from camera space (x,y) into projected space (x′,y′) are related by the bivariate polynomial: x′=xCₓy^{T} x′=xCₓy^{T} and y′=xC_{y}y^{T}; where Cₓ and C_{y} represent polynomial coefficients in matrix-form, and x and y are the vectorised powers of x and y respectively. Then we may design Cₓ and C_{y} such that we can assign a projected space grid location (i.e. memory location) by evaluation of the polynomial:

b=└x′┘+X└y′┘

Where X is the number of grid locations in the x-direction in projector space, and └.┘ is the floor operator. The polynomial evaluation may be implemented, say, in Chebyshev form for better precision performance; the coefficients may be assigned at calibration. Further background can be found in our published PCT application WO2010/073024.

Once a set of candidate finger positions has been identified, these are passed to a module 314 which tracks finger/object positions and decodes actions, in particular to identity finger up/down or present/absent events. In embodiments this module also provides some position hysteresis, for example implemented using a digital filter, to reduce position jitter. In a single touch system module 314 need only decode a finger up/finger down state, but in a multi-touch system this module also allocates identifiers to the fingers/objects in the captured images and tracks the identified fingers/objects.

In general the field of view of the touch sense camera system is larger than the displayed image. To improve robustness of the touch sensing system touch events outside the displayed image area (which may be determined by calibration) may be rejected (for example, using appropriate entries in a threshold table of threshold module 306 to clip the crude peak locator outside the image area).

### Auto-Calibration, Synchronization and Optical Techniques

We will now describe embodiments of various techniques for use with a touch sensitive display device, for example of the general type described above. The skilled person will appreciate that the techniques we will describe may be employed with any type of image projection system.

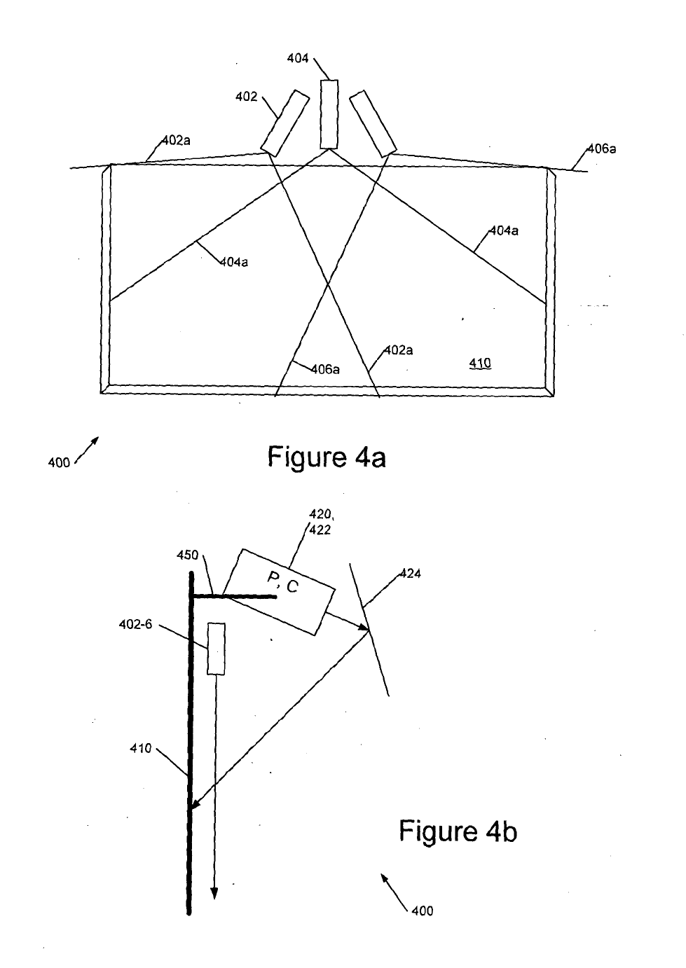

Thus referring to first FIG. 4, this shows plan and side views of an interactive whiteboard touch sensitive image display device 400.

As illustrated there are three IR fan sources 402, 404, 406, each providing a respective light fan 402a, 404a, 406a spanning approximately 120° (for example) and together defining a single, continuous sheet of light just above display area 410. The fans overlap on display area 410, central regions of the display area being covered by three fans and more peripheral regions by two fans and just one fan. This is economical as shadowing is most likely in the central region of the display area. Typical dimensions of the display area 410 may be of order 1 m by 2 m. The side view of the system illustrates a combined projector 420 and touch image capture camera 422 either aligned side-by-side or sharing at least an output portion of the projection optics. As illustrated in embodiments the optical path between the projector/camera and display area is folded by a mirror 424. The sheet of light generated by fans 402a, 404a, 406a may be close to the display area, for example less than 1 cm or 0.5 cm above the display area. However the camera and projector 422, 420 are supported on a support 450 and may project light from a distance of up to around 0.5 m from the display area.

We first describe auto-calibration using a calibration pattern projected from projector: The projector itself can project a pattern containing identifiable features in known locations. Examples include a grid of lines, randomly positioned dots, dots in the corners of the image, single dots or lines, crosshairs, and other static or time-varying patterns or structures. If the camera 258, 260 can see this pattern then the system can use this for calibration without any need for manual referencing by the user.

Such auto-calibration may be performed, for example: (1) when an explicit calibration operation is requested by the user; and/or (2) when an explicit calibration operation is triggered by, for example, system startup or shutdown or a long period of inactivity or some automatically-gathered evidence of poor calibration; and/or (3) at regular intervals; and/or (4) effectively continuously.

When implementing this technique the camera is made able to see the light the projector emits. In normal operation the system aims to remove IR from the projector's output and to remove visible light from the camera's input. One or other of these may be temporarily deactivated for auto-calibration. This may be done (a) by physically moving a filter out of place (and optionally swapping in a different filter instead) when calibration is being done; and/or (b) by having a filter or filters move in and out of use all the time, for example using the projector's color wheel or a second “color wheel” applied to the camera; and/or (c) by providing them with camera a Bayer-like filter (FIG. 5c) where some pixels see IR and some pixels see visible light. Such a filter may be combined with an anti-aliasing filter, for example similar to those in consumer digital cameras, so that small features are blurred rather than arbitrarily either seen at full brightness or missed depending on their location relative to the IR/visible filter.

It is also desirable to share at least a portion of the optical path between the imaging optics (projection lens) and the touch camera optics. Such sharing match's distortion between image output and touch input and ameliorates the need for cross-calibration between input and output, since both (sharing optics) are subject to the substantially same optical distortion.

Referring now to FIG. 5a, this shows an embodiment of a touch sensitive image display device 500 arranged to implement an auto-calibration procedure as described above. In the illustrated example an arc lamp 502 provides light via a color wheel 504 and associated optics 506a, b to a digital micro minor device 508. The color wheel 504 sequentially selects, for example, red, green, blue and white but may be modified to include an IR “color” and/or to increase the blanking time between colors by increasing the width of the separators 504a. In other arrangements switched, substantially monochromatic laser or LED illumination is employed instead. The color selected by color wheel 504 (or switched to illuminate the DMD 508) is known by the projector controller but, optionally, a rotation sensor may also be attached to wheel 504 to provide a rotation signal output 504b. A DMD is a binary device and thus each color is built up from a plurality of sub-frames, one for each significant bit position of the displayed image.

The projector is configured to illuminate the display surface at an acute angle, as illustrated in FIG. 5b, and thus the output optics include front end distortion correction optics 510 and intermediate, aspheric optics 512 (with a fuzzy intermediate image in between). The output optics 510, 512 enable short-throw projection onto a surface at a relatively steep angle.

Although the touch sense camera, 258, 260 may simply be located alongside the output optics, in some cases the camera is integrated into the projector by means of a dichroic beam splitter 514 located after DMD 508 which dumps IR from lamp 502 and directs incoming IR scattered from the sheet of light into sensor 260 of the touch sense camera via relay optics 516 which magnify the image (because the sensor 260 is generally smaller than the DMD device 508).

The dichroic beam splitter 514 is provided with a substantially non-absorbing dielectric coating, but the system may incorporate additional filtering, more particularly a broadband IR reject filter 518 and a notch IR pass filter 520 to filter out unwanted IR from the exterior of the projector/camera system.

Lamp 502 is typically a mercury discharge lamp and thus emits a significant proportion of IR light. This can interfere with the touch detection in two ways: light is transmitted through the projection optics to the screen and reflected back through the camera optics; and IR light is reflected inside the projection optics back to the camera. Both these forms of interference can be suppressed by locating and IR blocking filter before any such light reaches the camera, for example as shown by filter 518 or, alternatively, just before or just after color wheel 504.

Continuing to refer to FIG. 5a, notch filter 520 may be mounted on a mechanical actuator 522 so that the notch filter is switchable into and out of the optical path to sensor 260 under control of the system controller. This allows the camera to see the visible output from the projector when a calibration image is displayed.

Referring to FIG. 5b, this shows an alternative arrangement of the optical components of FIG. 5a, in which like elements are indicated by like reference numerals. In the arrangement of FIG. 5b the aspheric intermediate optics are duplicated 512a, 5, which enables optics 512b to be optimized for distortion correction at the infrared wavelength used by the touch sensing system. By contrast in the arrangement of FIG. 5a the optics 510, 512 may be optimized for visible wavelengths since a small amount of distortion in the touch sensing system is generally tolerable.

As illustrated schematically by arrow 524 in FIGS. 5a and 5b, it can be advantageous to defocus the relay optics 516 slightly so that the image on sensor 260 is defocused to reduce problems which can otherwise arise from laser speckle. Such defocus enables improved detection of small touch objects. In embodiments the optics 524 may be modified to add defocus only onto the vertical axis of the sensor (the vertical axis in FIG. 4a).

FIG. 5c illustrates an example Bayer-type spatial filter 530 which may be located directly in front of camera sensor 260 so that some pixels of the sensor see visible light and some IR light. As previously mentioned, if this is done, filter 530 may be combined with an anti-aliasing filter for improved touch detection. Such an anti-aliasing filter may comprise, for example, a pair of layers of birefringent material.

Continuing to refer to the optical configuration and image capture, as previously mentioned the projector may itself be a source of light interference because the camera is directed towards the image display surface (and because where the camera shares optics with the projector there can be other routes for light from the projector to reach the camera. This can cause difficulties, for example, in background subtraction because the light output from the projector varies for several reasons: the projected image varies; the red, green and blue levels may vary even for a fixed image, and in general pass through the filters to the camera in different (small) amounts; and because the projectors imaging panel may be a binary device such as a DMD which switches very rapidly within each frame.

These problems can be ameliorated by synchronizing the capture of the touch sense image with operation of the projector. For example the camera may be triggered by a signal which is referenced to the position of the color wheel (for example derived from the color wheel or the projector controller). Alternatively the image capture rate of the touch sense camera may be arranged to be substantially different to the rate at which the level of interference from the projected image varies. In this case the interference effectively beats at a known difference frequency, which can then be used to reject this light component by digital filtering. Additionally or alternatively, irrespective of whether the previously described techniques are employed, the system may incorporate feedback, providing a signal related to the amount of light in the image displayed by the projector, to the touch system. The touch system may then apply light interference compensation dependent on a level of this signal.

Referring now to FIG. 5d, this shows a system similar to that illustrated in FIG. 3a, but with further details of the calibration processing and control system. Thus the system controller incorporates a calibration control module 502 which is able to control the image projector 118 to display a calibration image. In the illustrated embodiment controller 502 also receives a synchronization input from the projector 118 to enable touch sense image capture to be synchronized to the projector. Optionally in a system where the projector is able to project an IR image for calibration controller 552 may suppress projection of the sheet of light during this interval.

A captured calibration image is processed for ambient light suppression and general initial filtering in the usual way and is then provided to a position calibration module 554 which determines the positions of the reference points in the displayed calibration image and is thus able to precisely locate the displayed image and map identified touch positions to corresponding positions within the displayed image. Thus position calibration module 554 provides output date to the object location detection module 314 so that, if desired, this module is able to output position date referenced to a displayed image.

It will be appreciated that for the touch sensing system to work a user need not actually touch the displayed image. The plane or fan of light may be invisible, for example in the infrared, but this is not essential—ultraviolet or visible light may alternatively be used. Although in general the plane or fan of light will be adjacent to displayed image, this is also not essential and, in principle, the projected image could be at some distance beyond the touch sensing surface. The skilled person will appreciate that whilst a relatively thin, flat sheet of light is desirable this is not essential and some tilting and/or divergence or spreading of the beam may be acceptable with some loss of precision. Alternatively some convergence of the beam towards the far edge of the display area may be helpful in at least partially compensating for the reduction in brightness of the touch sensor illumination as the light fans out. Further, in embodiments the light defining the touch sheet need not be light defining a continuous plane—instead structured light such as a comb or fan of individual beams and/or one or more scanned light beams, may be employed to define the touch sheet.

### Multi-touch

We have previously described systems for simultaneously detecting multiple finger/object touches (our GB 1110156.5, U.S. 61/508,857 filed 16/18 Jun. 2011 respectively, incorporated by reference).

As described above, in a multi-touch system module 314 allocates identifiers to the fingers/objects in the captured images and tracks the identified fingers/objects. Thus in an example multi-touch system the processing prior to the finger decode module 314 determines multiple sets of coordinates for respective candidate finger positions resulting from simultaneous touch events. Module 314 then attempts to link each candidate position with a previously identified finger/object, for example by attempting to pair each candidate position with a previously identified position in embodiments based on a measure of probability which may include (but is not limited to) distance between the previous and current positions, brightness of the scattered light and, optionally, size/shape of the image of the scattered light from the object/finger. Optionally when linking a present position to previous position the radius of the search may be dependent on a previously estimated speed of motion of the finger/object and/or the search may be dependent on an estimate of a direction of motion of the finger/object, for example by employing a search region which is an isotropic and elongated in a direction of travel of the finger/object. Where a pairing cannot be made then a finger up/down event may be generated depending on whether, respectively, a previously identified finger has ‘vanished’ or on whether a new finger/object position has ‘appeared’.

In an example algorithm, when a first touch object/finger is detected this first object is assigned an identifier of ‘Finger 1’, and then when the number of detected simultaneous touches increases or decreases the procedure steps through the new, candidate position coordinate list (in any order) assigning each coordinate with an identifier corresponding to the respective identifier of the closest coordinate in the old (previous) list, up to a maximum radius limit. For a candidate object position beyond this radius limit of any previously identified position, a new identifier is assigned.

This procedure may be extended to distinguish between objects based upon their size and/or shape, for example to distinguish between a finger and thumb or between a finger and an object such as a pointer or even between different individual fingers. The system may also be configured to differentiate between large and small pointers or other objects so that, for example, in a drawing application a large object may act as an eraser and a smaller object may act as a brush.

An example set of touch position output data 316 may comprise two-dimensional position coordinates x for each identified finger and/or other objects, as indicated in the table below:

| Frame | Finger 1 | Finger 2 | Finger 3 | Finger 4 | Finger 5 | Finger 6 | Object A |
|---|---|---|---|---|---|---|---|
| i − 2 | | | | | | | |
| i − 1 | X₁^{i - 1} | X₂^{i - 1} | X₃^{i - 1} | X₄^{i - 1} | X₅^{i - 1} | X₆^{i - 1} | X_{A}^{i - 1} |
| i | X₁ⁱ | X₂ⁱ | X₃ⁱ | X₄ⁱ | X₅ⁱ | X₆ⁱ | X_{A}ⁱ |
| i + 1 | | | | | | | |

In this example the six ‘fingers’ include a thumb, but in principle there may be more identified finger positions than five or six. Optionally one finger, for example Finger 1 may be designated as a ‘mouse’, in which case if Finger 1 vanishes the next brightest finger may be allocated as the mouse. It will be appreciated from the table that from the history of finger position data finger direction and/or speed may be estimated.

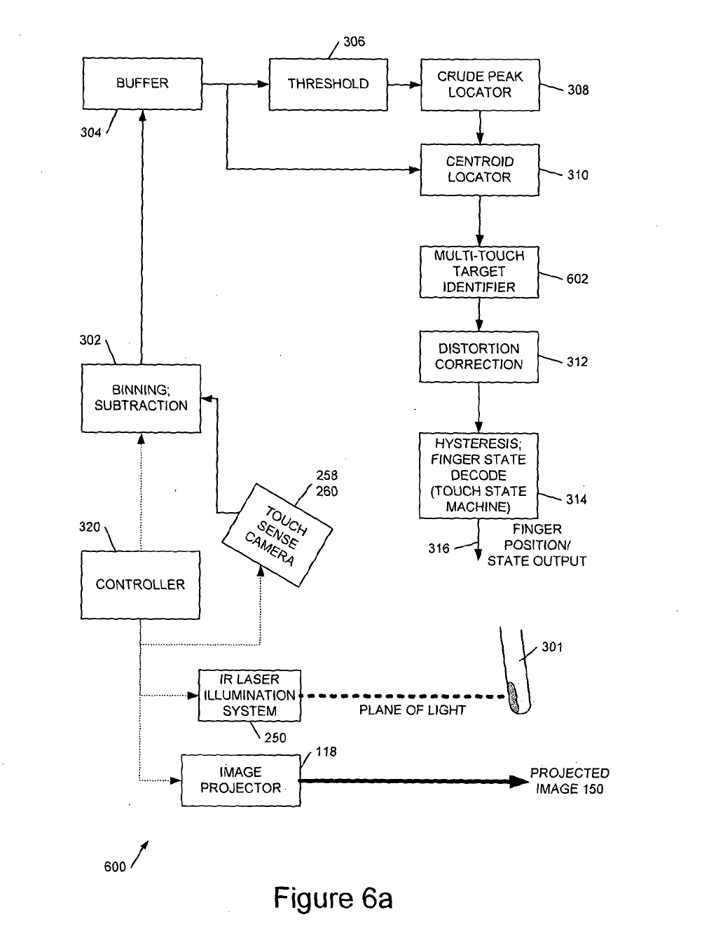

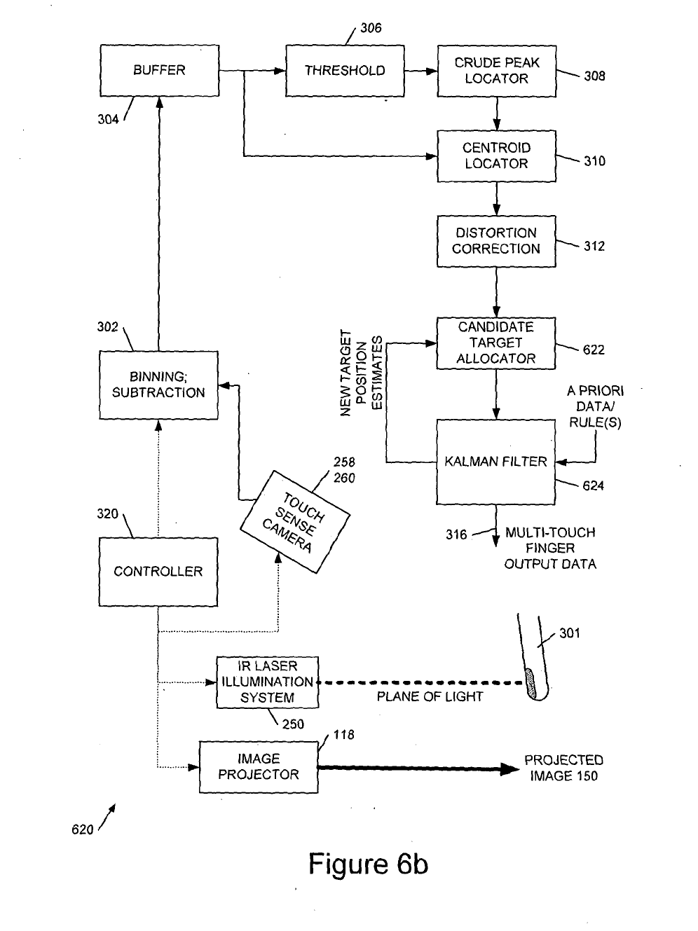

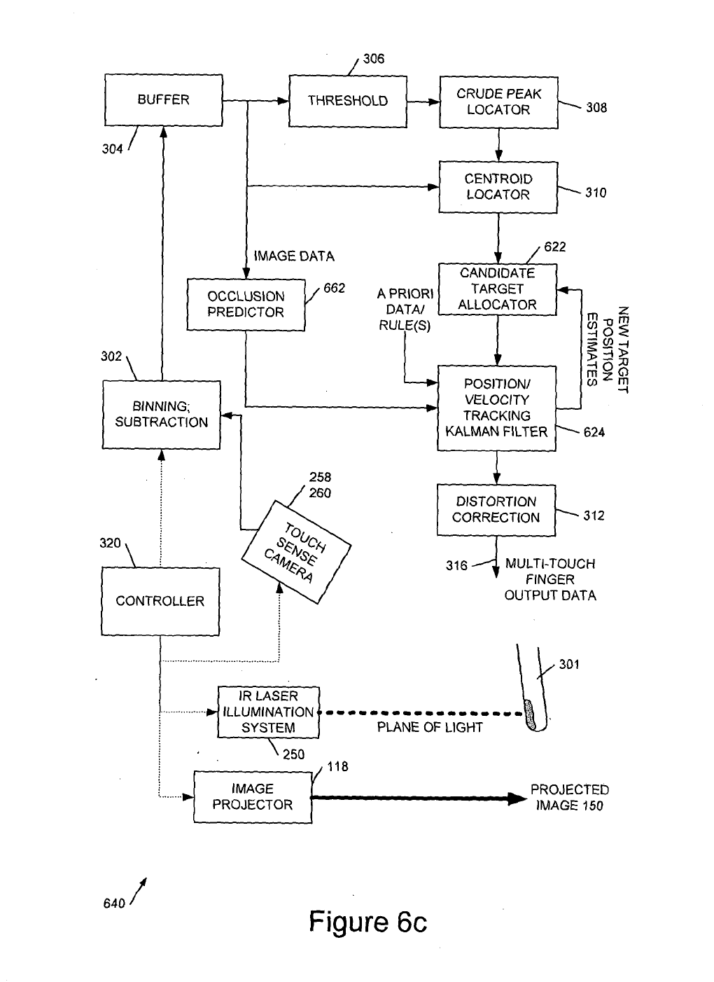

FIG. 6a shows a multi-touch system 600 incorporating a multi-touch target identifier module 602. In embodiments multiple finger identifiers are tracked by linking new candidate object positions to previously identified object positions as previously described, for example filtering on intensity and adjacency, using the multi-touch target identifier module. In embodiments this tracking is performed in touch sense camera space rather than image space that is prior to distortion correction. However this is not essential and in the described embodiments the distortion correction may be performed either before or after object position identification and tracking.

Referring now to FIG. 6b, this shows a touch sensitive image display device 620 employing a more sophisticated tracking filter 624, for example a Kalman filter which operates on the candidate object positions and previous position data to produce a set of object position estimates, optionally accompanied by uncertainty (variance) data for each (although this latter data may not be needed). In some cases, the Kalman filter operates in conjunction with a candidate target allocator 622, which may receive predicted position estimates for each of the identified objects from the Kalman filter to facilitate linking a candidate object with a previously identified object. The skilled person will be aware of a range of multiple target tracking algorithms which may employ with such a combination of a target allocator and Kalman filter.

Use of a Kalman filter also facilitates the incorporation of a priori data/rules to facilitate touch detection. For example a rule may be implemented which disregards a tracked object if the object is motionless for greater than a predetermined duration of time and/or if the object is greater than a threshold size (as determined by the area of scattered light in a captured touch sense image). Potentially constraints on finger motion may also be included—for example a finger and thumb are generally constrained to move towards/away from one another with a limited range of overall rotation.

A tracking or Kalman filter may also incorporate velocity (and optionally acceleration) tracking. Consider, for example, two regions of scattered light moving towards one another, coalescing and then moving apart from one another. With a touch sensing system of the type we describe this could either result from a pair of fingers moving towards and then away from one another or from a pair of fingers moving passed one another in opposite directions. In the first case there is a change in acceleration; in the second case the velocity may be substantially constant, and this can allow these events to be distinguished.

A related difficulty occurs when one object is occluded behind another in the plane of light—that is when one object is shadowed by another. Whether or not a Kalman or tracking filter is employed, some of these events may be distinguished using an area calculation—that is two coalesced objects may be distinguished from a single object on the basis of area (of scattered light) in a captured image, thresholding to distinguish between the two.

Additionally or alternatively, whether or not a tracking or Kalman filter is employed, the finger identification module may track an imaginary finger, that is the system may allocate an identifier to a finger and maintain this identifier in association with the coalesced or shadowed area until the object is seen to reappear as a separate, distinct object in a subsequent captured image, allowing continuity of the allocated identifier.

Thus, in a touch sensing system of the type we describe, because of the acute angle of the camera to the detection plane, and also because of the extent of the finger above the detection plane, one finger may pass behind another during multi-touch movement, occluding the first finger and obscuring its location. This problem can be addressed by providing a predicted or estimated position for the occluded finger location, for example by motion vector continuation or similar, until the occluded finger re-emerges into the captured image and position data is once again available for the finger.

A tracking or Kalman filter as described above can be used to implement this approach (although other techniques may alternatively be employed). Thus, optionally, a touch sensitive image display device 640 as shown in FIG. 6c may include an occlusion prediction module 662 having an input from the captured image data and an output to the tracking filter 624. The occlusion predictor may operate by extending the edges of each region of scattered light back in the image in a direction away from the IR laser illumination.

### Touch/Object Matching

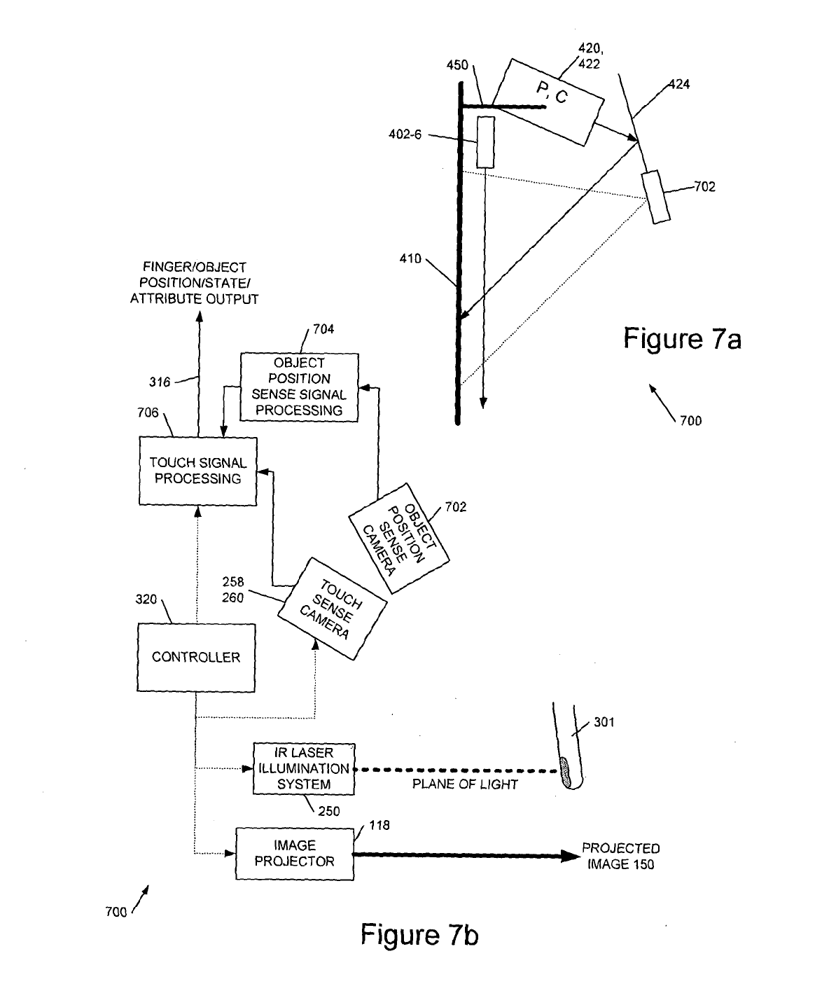

Referring now to FIGS. 7a and 7b, these show a touch sensing system 700 incorporating a second object position sensing subsystem according to an embodiment of the invention, in combination with an image projector. Again like elements to those previously described are indicated by like reference numerals.

Thus in FIG. 7, the system includes a visible light camera 702 to capture an image of the spatial volume in front of the display surface, coupled to an image processing module 704 which provides data to a touch sense signal processing system 706, for example as previously described with reference to FIG. 5d and/or FIG. 6. As previously described, in some case the touch signal processing module 706 tracks one or multiple touch positions; in one or more cases, the object position sensing module 704 also tracks the position of one or more objects for example using similar technology such as a Kalman filter, αβ filter or the like. In some embodiments this module detects a feature of one or multiple objects, for example an object color from a size or shape, and this information is then used to provide this object attributes data in association with the touch position data on output 316. In this way, for example, the positions and colors of multiple pens and, optionally, an erasure may be tracked. The skilled person will appreciate, however, that there are many other related applications for which this technology may be employed, further optionally an object may include a visually distinguishable code such as a barcode, and this may additionally or alternatively be employed to provide additional information about an object, for example by looking up data relating to the object from a local or remote stored look up table or database.

Additionally or alternatively the tracked object position data may be employed to assist the touch signal processing when an object/finger is in an occluded location. Thus the additional information provided by the visible light camera can be used to track an object whilst the 2D touch sensing sub system is occluded or at least to identify whether/when the occluded object is still present. This latter facility is straightforward but particularly helpful; in such a case because the object tracking may be relatively inaccurate tracking maybe continued by the touch subsystem, extrapolating from previous distance and/or velocity information. there maybe two different types of occlusion for the touch subsystem, one where an object is not illuminated because another object intercepts the sheet of light nearer to the source(s); another where one object or something it is connected to, for example a finger and hand, obscures part of the field of view of the touch sensing camera. Combining information from the object tracking system with the touch sensing subsystem can ameliorate either or both of these issues.

In a still further implementation, which may optionally be combined with the above techniques, the object sensing subsystem/signal processing 702, 704 is employed to provide an object, in particular a passive object (that is one that lacks an electrical power source) with one or more user controls, such as a left-click and/or right-click button. In embodiments of this approach a mechanical control may be employed to selectively alter the visual light response of the object to provide one or more different, visually distinguishable patterns on one or more regions of the object. These may then be identified and distinguished by the object sensing subsystem for example to provide left-click and right-click functions. Thus in one implementation a passive pen has two different colored regions which are selectively revealed dependent on a button press, and the resulting change in appearance is detected to provide user control output data signifying operation of a ‘passive’ user control on the object. The skilled person will appreciate that any visual means of distinguishing different regions on the pen will suffice, for example different color/pattern/texture/shape and so forth. The skilled person will also appreciate that embodiments of this technique merely require that the visual appearance of the object is user configurable so far as is seen by the object sensing camera 702. Thus in a further approach the object is provided with different, visually distinguishable regions on different parts or sides of the object, for example a pen or pen nib with one side in one color, say red and another side, for example the opposite side, in a different color, say blue.

In a variant of this technique, an end portion of the pen or other object, for example the pen tip or nib, may be given a characteristic IR response, for example to enhance the IR light captured by the touch camera, and the body of the object may be given a different characteristic, distinguishable in visible light, for example a color.

In a still further variant, which again may be used in conjunction with or independently of the above described techniques, the object sensing camera/signal processing 702, 704 may be configured to identify one or more skin tones. Thus in one embodiment the object sensing sub system is configured to selectively detect skin tones and this information is used to weight the probability that an occluded object is still present and/or to weight the probability that a detected object is a genuine target such as a pen. This is useful, for example, where the object sensing sub-system temporarily loses sight of an object such as a pen, for example because it is partially or wholly obscured from the view of the visual camera by the hand holding it. In this case tracking may be continued if the presence of skin tone is detected. In a similar manner the presence of skin tone near a putative target object may be used to increase the probability that the detected object is in fact a genuine target. This may be implemented using an input into a Kalman filter, along similar lines to those previously described with reference to FIG. 6C for the touch sub-system.

More generally, the output of the object position sensing sub-system may provide an input to the Kalman filter 624 of FIG. 6C of the touch sensing sub-system, to incorporate the object position data into the touch location detecting system. The skilled person will appreciate when combinations of the above described techniques are employed multiple different “filters” may be employed on the object sensing image data and provided in combination to the touch sensing sub-system; optionally where more data is available even where this is less accurate, the overall location accuracy may be enhanced.

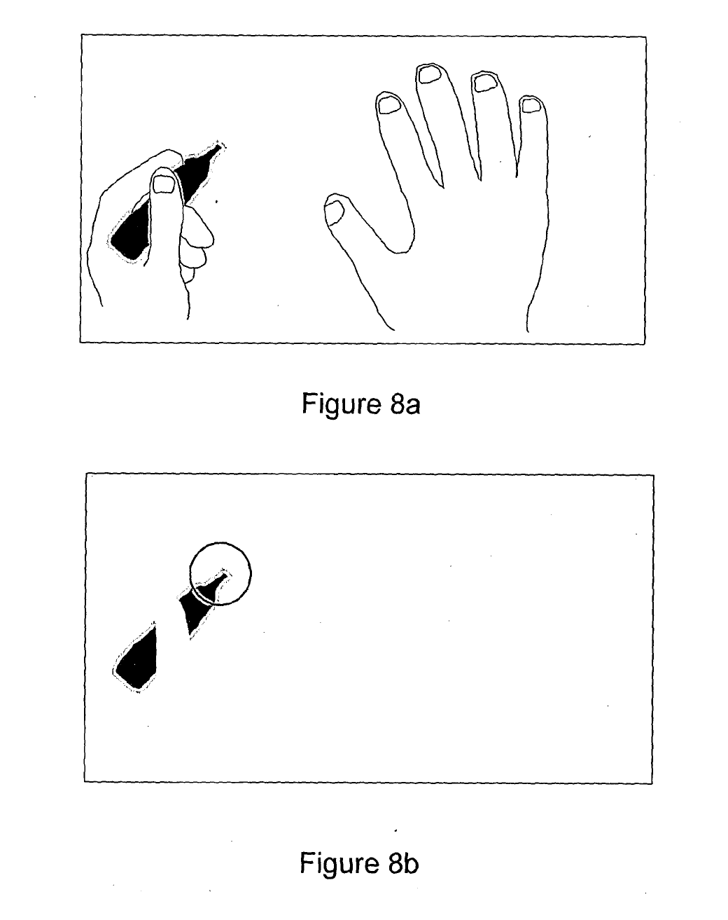

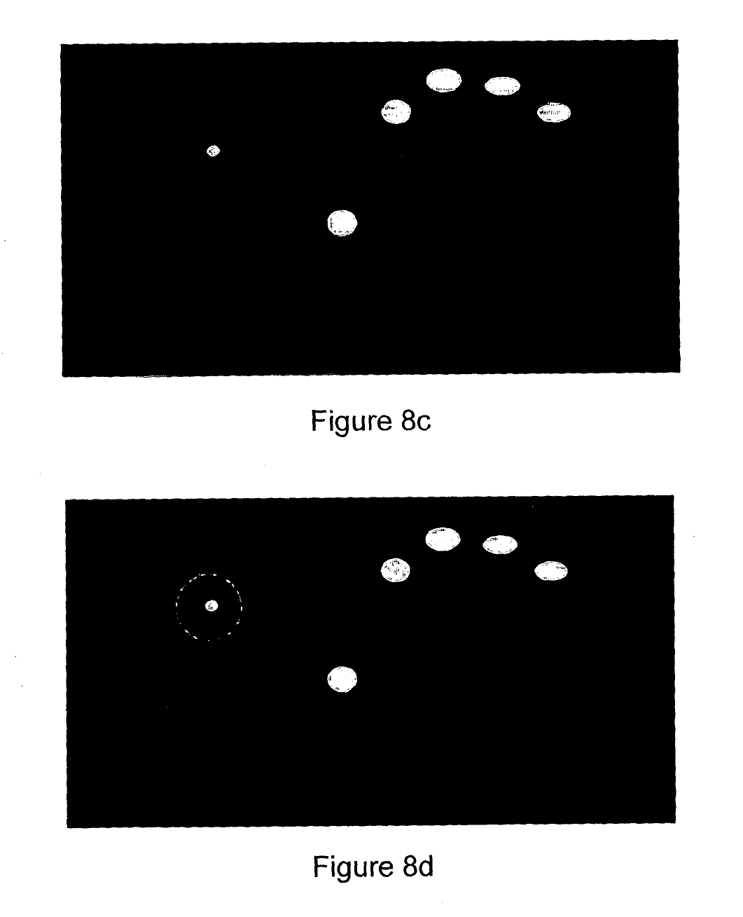

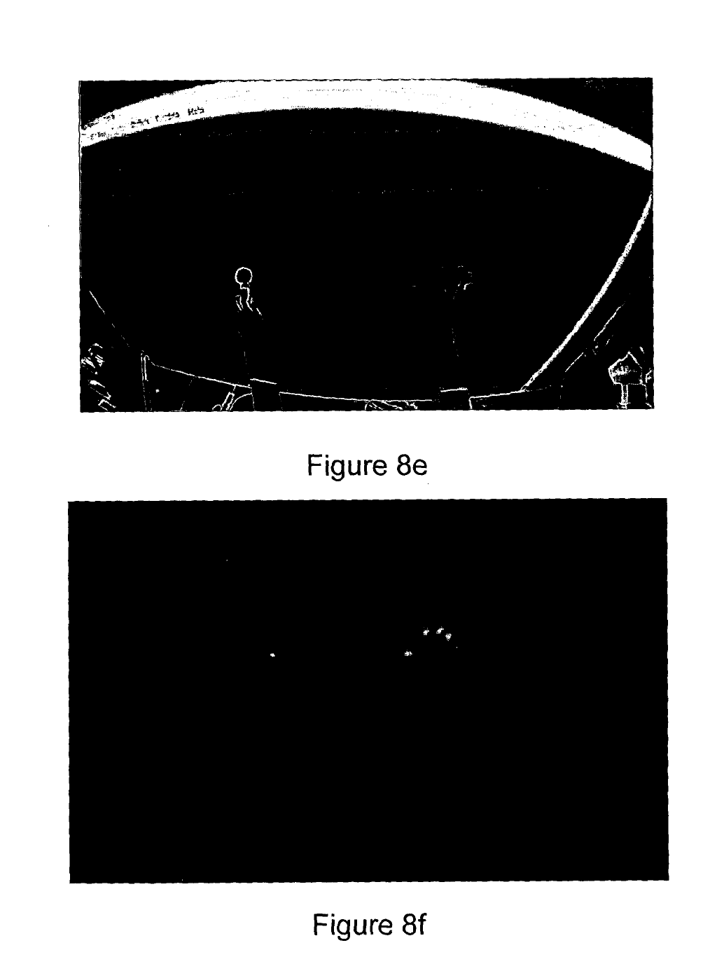

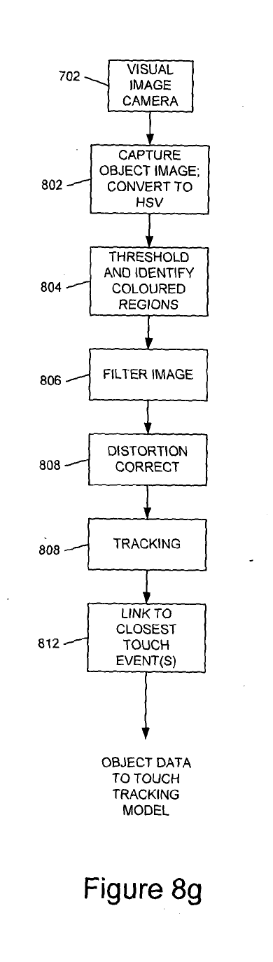

In embodiments of the system shown in FIG. 7, the accurate touch location information is provided by the touch sensing sub-system and the object sensing sub-system need only provide relatively low accuracy information in particular where, for example, this is merely being used to identify an object color or the like. This skilled person will appreciate, however, that even where low accuracy object detection is employed, the visual camera itself may be of lower or higher resolution than the touch sensing camera. Further, the skilled person will appreciate that even where the object sensing sub-system may determine an apparent position of an object with relatively high precision, for example by calculating a centroid, this does not necessary imply that the calculated result is an accurate representation of the object's location. Thus, as previously mentioned, it has been found experimentally that it can be desirable to detect an edge of an object rather than say a centroid of the object, in particular the location of an edge of an object closest to the visual camera. This can be appreciated from FIG. 8e, described later, from which it can be seen that an object approaching the touch/display surface will enter the field of view of the visual camera from the bottom (away from the visual camera) and halt when it reaches the touch/display surface at a position which is uppermost (towards the visual camera) in the camera's field of view—and thus for an object touching display surface the “upper” edge of the object or a position determined from or in relation to this, tends to represent the most accurate position of an object sensed by the object sensing sub-system.

Referring next to FIG. 8, FIG. 8a shows, schematically, an example of a visual image captured by camera 702; and FIG. 8b shows the output of a stage in the image processing following filtering by one or more selected colors and/or saturation, for example to detect one or more target pen colors. The Figure also illustrates identification of an edge, more particularly a point on the object (filtered image) which is nearest the top of the image; this indicates a putative location for the object. FIG. 8b also illustrates a circle around the putative object location; in embodiments the radius of this circle denotes, effectively, the boundary of a search area having an origin on the object location, within which the detected object location maybe linked to a detected touch location. More generally, however, the output of an object position sensing system may comprise a probability which varies with position, for example a probability density function, which is then used to match an object location from the object sensing system with a corresponding location from the touch subsystem. In embodiments such a probability density function is generated, effectively automatically by the image processing, for example by correlating the image with an object feature such as pattern/size/color/shape and the like. For example, in some cases, a shape recognition algorithm is applied to the visual camera image to detect pen-tip shaped objects, either in any orientation or with a constrained orientation of the type illustrated in FIGS. 8a and 8b. More generally where shape detection processing is applied this may be constrained by either or both of size and angle, as well as optionally, color and/or pattern.

FIG. 8c shows, schematically, an example IR image captured by the touch sense camera, and FIG. 8d a combination of the IR and processed visible images of FIGS. 8c and 8b showing, in this example, that one identified touch from the touch subsystem appears within the object (pen) search region of FIG. 8b, thus allowing this touch to be classified as an object/pen touch, and afterwards linked with an attribute visually detected attribute of the pen, for example, the color green. It will be appreciated that in some cases similar techniques are applied to the shape of the object and so forth.

FIG. 8g shows a flow diagram of one example of image processing performance by module 704 of FIG. 7b. We will describe, in particular an example to detect pen color.

Thus at step 802 an image is captured from camera 702 and, in embodiments, converted to HSV (hue saturation value) color space. This data is then processed at step 804 to filter out regions with less than a threshold saturation (to identify the colored regions), and to filter out regions which have greater than a threshold minimum HSV value (so that the processed image is not too dark). The procedure then identifies connected colored image regions, optionally (not shown in FIG. 8g) filtering by expected/known touch locations determined by the touch sensing subsystem: thus embodiments may reduce the processing load and improve performance by effectively restricting object tracking to touch locations. Further optionally processing step 806 filters the image by one or more of object size, shape, color, orientation and so forth as previously described, again optionally restricting to regions identified as touch regions by the touch sensing subsystem. Thus, in some implementations the object sensing system may restrict processing/tracking to objects of the target size/shape/color.

Then at step 808 the procedure provides distortion correction to map into the touch space (where location information from the touch sensing subsystem is used to restrict object image processing as previously described, in some cases these coordinates are corrected for distortion in between the touch sensing and object sensing spaces); then optionally object tracking 810 is performed to improve object existence/position or accuracy information. The system then links 810 to the closest touch event or events, and then outputs object attribute data to the touch tracking module in order that the touch sensing subsystem can report object properties such as pen color in association with the object location(s). The skilled person will appreciate that in some cases this technique may be employed to detect multiple objects in a multitouch system using essentially the same process, without much increase in processing load.

In embodiments of the procedure the object motion tracking may employ digital filtering and smoothing in the time domain to provide improved performance over frame-by-frame processing. Such an approach also helps to provide persistence to attract object, which is useful as where, say, an object is momentarily occluded (to the visual camera) there is a significant likelihood that it still exists as a touch object. Thus referring back to FIG. 8b, this illustrates partial occlusion of an object by hand; at time an object may be substantially completely occluded. Embodiments of the procedure at FIG. 8g, as well as identifying one or more target colors also identify the presence of skin tone. Thus one example embodiment may detect the object color (target color), a combination of the object color and a second, skin tone color, and the presence of the skin toned color; these may be combined so that the detection or likely presence of an object may be responsive to a combination of one or more of these. In this way the system can more reliably detect, say, a green pen when the pen is being held in a hand which may occasionally obscure the green color of the pen.

In embodiments (additionally or alternatively to the above described implementation) detection of skin tone may be used to distinguish between different individuals using a multitouch system at the same time: it has been found that different individuals have distinguishable skin tones (even individuals with the same nominal skin color), and thus embodiments of the system may match object colors (within a tolerance) to link one or more detected objects associated with a common individual user, and thence to distinguish between users.

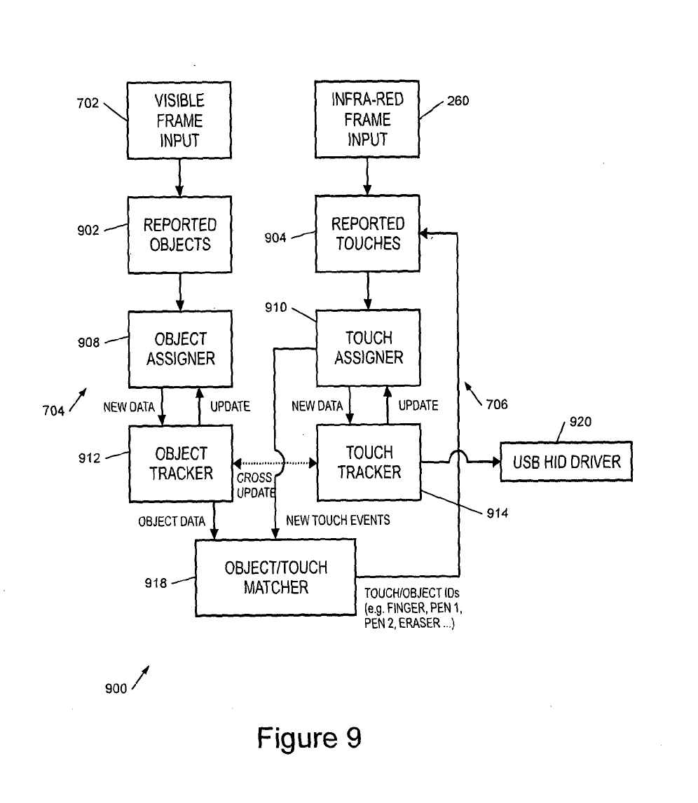

As previously mentioned, some implementations of the system track both objects from the object sensing subsystem and touch sense locations in the touch sensing subsystem. In some embodiments each system has an ‘internal view’ of which objects/touches are where, and this may be shared with the other system. Thus referring to FIG. 9, this shows an embodiment of a combined touch and object sense signal processing system which may be implemented by a combination of modules 704 and 706 of FIG. 7b.

Thus the combined touch/object signal processing system 900 of FIG. 9 comprises a module 902 to detect and report objects and a corresponding module 904 to detect and report touches each, for example, as previously described. The reported objects provide an input to an object assigner 908 which identifies objects as previous/new; and the corresponding touch assigner 910 performs a similar task for the reported touches. The object assigner 908 is coupled to an object tracker 912 which receives object data from the object assigner 908, defining object position and associated characteristic data and provides updated state data back to the object assigner so that, for example, object states may have persistence. The touch single processing chain comprises a touch tracking module 914 coupled to touch assigner 910, which performs a similar function to object tracker 912. In embodiments one of the object/touch tracker, 912, 914 may update the other; in some cases each updates the other as indicated by dashed line 916. The data exchanged may comprise object/touch position and/or velocity data for the identified objects/touches.

An object/touch matching module 918 receives data on touch events from touch assigner 910 and object data from object tracker module 912, linking these together, for example based on respective object/touch probability distributions, identifying where these overlap with greater than a threshold value. The object/touch matching module provides touch/object identification data back to the reported touches module 904 comprising, for example, identifying whether a touch is a finger, a pen having a certain characteristic (pen 1, for example green), an optional erasure object and the like. Object position/property data is, in this example, provided as an output from touch tracker module 914, as illustrated to a human interface device driver 920, here a USB (universal serial bus) interface.

The skilled person will recognize that alternatives to the data flow illustrated in FIG. 9 are possible—for example data may flow only one way through the object/touch processing chains; data may be shared between the processing chains at different levels to the object/touch tracker module level illustrated; the linking of object data and touch events may be performed by a module coupled to different modules within the object/touch chains than the object tracker and touch asylum modules; and the output data may be taken form a different stage in the processing or from the object rather than the touch processing stages.

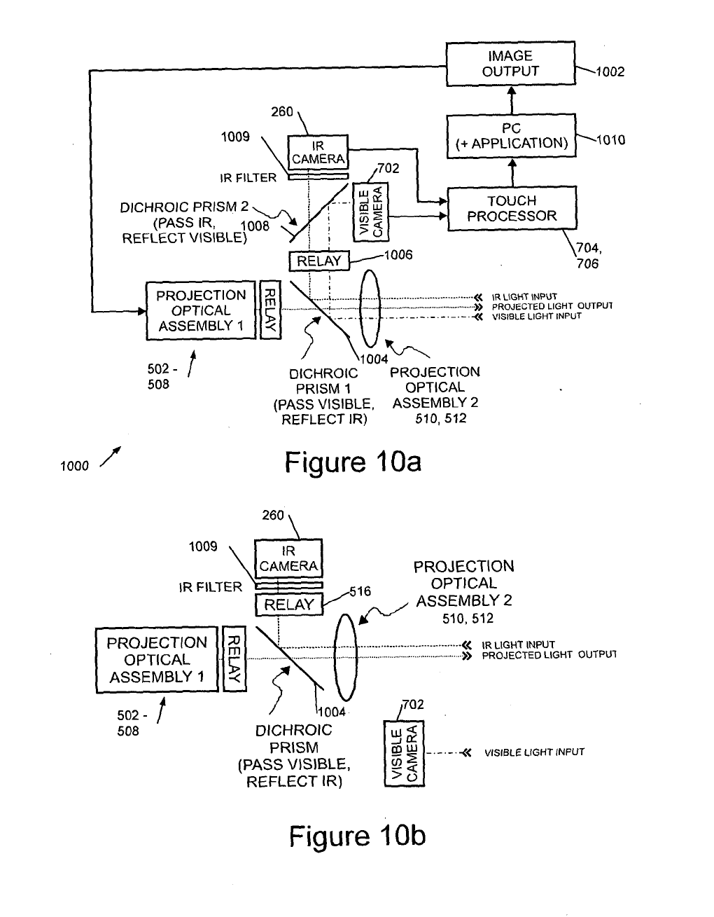

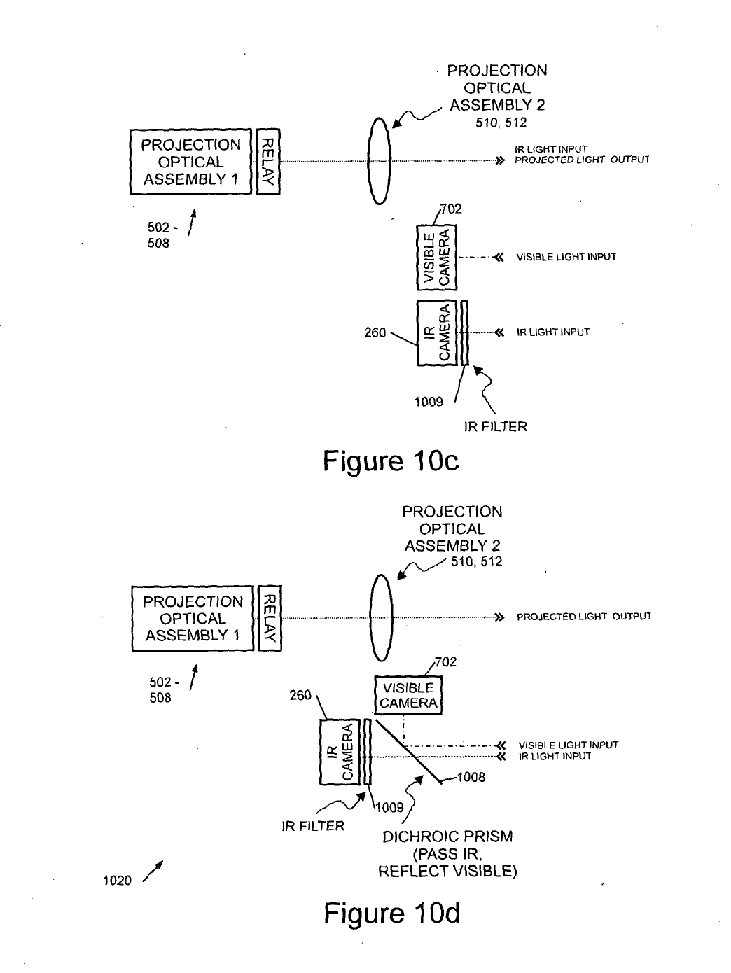

Referring next to FIG. 10a, this shows a touch sensitive image projection system 1000, for example for an interactive whiteboard application, according to an embodiment of the invention. The system comprises a DLP (digital light processor) type projector having an image driver module 1002 to receive image data from, for example, application software running a computer 1010, and to drive a projection optical assembly 502-508 comprising, in this example, a DMD (as previously described with reference to FIG. 5a) the image projection system incorporates an IR camera 260 and variable camera 702 providing image data to a touch processing system 7094, 706 as previously described, which provides touch data input to the software running on computer 1010 comprising, for example, object identification and, where appropriate, characterization data—such as finger, pen 1, pen 2 and the like. As illustrated the touch processing system is incorporated into the image projector but, as described later, the touch sensing system may be mounted alongside an existing projector for ease of retrofitting.

As illustrated the output projection assembly 510, 512 outputs light to provide the projected, display image and receives infra-red light from the touch sheet and visible light from the 3D region in front of the display surface. In the particular illustrated example the incoming light is separated from the outgoing projected light by a dichroic prism 1004, passed to relay optics 1006, further split into IR and visible light by a second dichroic prism 1008 and provided to respectively, IR camera 260 and visible camera 702. Optionally an IR filter 1009 is provided in front of the IR camera sensor.

In the illustrated example the visible light input is separated from the projected light output using a filter 1004 which selectively passes the projected light at relatively narrow pass bands in, for example, the red, green and blue. Such an approach is in some cases employed with a projector which employs narrow bands LED or laser illumination sources for the DMD. The filter 1004 leaves gaps between the RGB projector output bands and the incoming visible light within these gaps is reflected towards visible camera 702. The skilled person will appreciate that variants on this approach are possible using combinations of one or more notch pass and notch reject filters to pass/reflect the desired visible input and projected output wavelengths. The skilled person will further appreciate that, in any of the embodiments described herein, although it may be desirable to employ a color camera for the visual camera 702, a monochromatic (or even IR sensitive or IR-restricted) camera may be employed for camera 702. This would simplify the approach of FIG. 10a although, in other approaches the visible light input is along a separate path to the projected light output.

Thus referring to FIG. 10b, this shows a variant of the approach of FIG. 10a in which the visible light input is separated from the projected light output from the projector; the other components of the system are omitted for simplicity.

FIG. 10c shows a further variant in which the IR camera is separated from the projected light output of the projector; and FIG. 10d shows an example system in which both the IR and visible cameras are separated from the output of the projector but provided in a common combined optical module 1020, for example for ease of retrofitting to an existing projector system. Optionally such a module may be provided with a magnetic attachment in a fiducial location on the module so that it can be attached in a predetermined position on the projector or folding mirror, to further simplify retrofitting.

With optical arrangements of the types illustrated in FIG. 10, a corresponding calibration system to that illustrated in FIG. 5d may be employed, projecting a pattern visible to both touch sense camera and the visible light camera and correcting a distortion in both these cameras using the same pattern so that distortion-corrected positions map accurately from one of these cameras to the other.

### Click Buttons

As previously mentioned, the object may be a passive object such as a pen incorporating user controls which change its appearance of object, for example by moving an aperture. (Here a “passive” object is one which lacks an electrical power source), in particular an internal battery or a wired electrical connection to an external power source.

This may be employed to hide one or another spot or to change a spot count on the object, or to change a number of lines or line slope or orientation, change in the polarization response of the object, or to modify the object appearance in some other way.

The user control on the object may comprise one or more buttons mechanically modifying an aspect of visual appearance of the object; operation of these virtual ‘user buttons’ may then be detected by the second sensing system and then provided as an output from the system for use in any desirable manner.

For example, in one embodiment, a passive pen of this type provides left-click and right-click buttons, so that the pen can send back one of three “signals”:
Touching the board
Touching the board and left-button pressed
Touching the board and right-button pressed

In this embodiment, pressing a “left” or a “right” button reveals a left-button identification or a right-button identification, which is detected by the system. For example, the pen may reveal two different colored regions which are distinguished using the second (visible light) camera. The signal processor may then be configured to detect this change in the object's appearance to identify operation of the user control and to output corresponding user control data in response.

In embodiments the user-controllable element may simply be a region on the pen or other object with which the user is able to selectively alter the response of the object when views with the second (visible) camera. Thus, for example, regions may have different color and/or brightnesses (light or dark spots) and/or polarization characteristics—and the user may simply cover one or more of these with a finger or change the orientation of the object/pen so that one or other is visible to the touch camera. For example, different sides of a pen nib or different ends of a pen may have a different IR color or response: in this case the user simply rotates or flips the pen to operate the user control.

Further, and particularly since the system is able to distinguish between an object such as a pen and a finger, a click button or similar user control may be implemented by detecting (momentary) touch of a finger to one or other side of, say, a pen, optionally within a limiting radius and/or angle. Additionally or alternatively a “click” may comprise a new pen (or other object) touch and a finger (or other object) touch within a limiting time and/or radius and/or angle to one another.

The techniques we have described are particularly useful for implementing large scale touch sensitive displays (>0.5 m in one direction), such as an interactive whiteboard although they also have advantages in smaller scale touch sensitive displays. No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A touch sensing system, for sensing the position of at least one object with respect to a surface, the system comprising:
a first, 2D touch sensing subsystem to detect a first location of said object with respect to a surface and to provide first location data;
a second, object position sensing subsystem to detect a second location of said object, wherein said second location of said object is not constrained by said surface, and to provide second location data;
a system to associate said first location data and said second location data and to determine additional object-related data from said association; and
a system to report position data for said object, wherein said position data comprises data dependent on at least one of said first and second locations and on said additional object-related data.

2. A touch sensing system as claimed in claim 1 wherein said second object-related sensing system comprises a system to detect a property of said object and to provide object property data in conjunction with said second location data, wherein said additional object-related data comprises said object property data.

3. A touch sensing system as claimed in claim 2 wherein said 2D touch sensing subsystem includes a tracking system to track said first location of said object, and wherein said system to associate said first and second location data is configured to link said object property data to said position data at an initial said first location where said first and second locations correspond, and to track said linked object property and position data thereafter dependent on said tracked first location.

4. A touch sensing system as claimed in claim 2 wherein said second object position sensing subsystem comprises a visible-light camera, and wherein said object property data comprises a color of said object.

5. A touch sensing system as claimed in claim 1, wherein said 2D touch sensing subsystem is configured to detect said first location to a first accuracy, and wherein said object position sensing subsystem is configured to detect said second location to a second accuracy lower than said first accuracy.

6. A touch sensing system as claimed in claim 1 wherein said touch sensing system is a multi-touch sensing system, wherein said second object position sensing subsystem comprises a position sensing system, to sense a 3D space in front of said surface, wherein said system to associate said first and second location data comprises a system to connect sensed touch locations from said 2D touch sensing subsystem to a common physical object in 3D space, and wherein said additional object-related data comprises data linking a plurality of said first locations from a plurality of portions of said common physical object.

7. A touch sensing system as claimed in claim 1 wherein said second object position system is configured to track said object as it moves in 3D away from said surface, and wherein said system to associate said first and second location data is configured to link successive registers of touches, by said 2D touch sensing subsystem, of said surface by said object, dependent on said second location data.

8. A touch sensing system for sensing in claim 1 wherein said second object position sensing subsystem is configured to process a captured image to detect said object, wherein said second object position sensing subsystem is coupled to said 2D touch sensing subsystem, and wherein said processing is spatially limited dependent on said first location data.

9. A touch sensing system as claimed in claim 1 further configured to distinguish between multiple touches of said surface responsive to said additional object-related data, and further comprising an action determination system responsive to detection of distinguished first and second objects touching said surface, wherein said action determination system is configured to determine an action responsive to said detection; optionally filtered responsive to one or both of a distance and a direction of one of said objects with reference to the other.

10. A touch sensing system for sensing in claim 1 further comprising said object, wherein said object is user configurable to control said additional object-related data, and further comprising an action determination system responsive to said additional object-related data to determine and output user action data responsive to user configuration of said object.

11. A touch sensing system as claimed in claim 1 further comprising an image projector to project a displayed image onto said surface, wherein said object position sensing subsystem comprises a visible-light camera and is coupled to receive projected image data relating to said projected image and to process an image from said camera responsive to said projected image data to attenuate a response of said camera to distraction by said projected image.

12. A touch sensing system as claimed in claim 3 wherein said object position sensing subsystem is configured to detect a different said object at said second location, and wherein said system to associate said first and second location data is configured to link successive intersections of said surface by said object dependent on said second location data.

13. A touch sensing system for sensing as claimed in claim 1 wherein said additional object-related data comprises occlusion data identifying presence of said object in an occluded region of said touch sensing subsystem, and wherein said position data is dependent on said occlusion data.

14. A touch sensitive image display device, the device comprising:
an image projector to project a displayed image onto a surface;
a touch sensor optical system to project light defining a touch sheet above said displayed image;
a first camera directed to capture a touch sense image from a region including at least a portion of said touch sheet, said touch sense image comprising light scattered from said touch sheet by an object approaching said displayed image; and
a signal processor coupled to said first camera, to process a said touch sense image from said first camera to identify a location of said object relative to said displayed image;
further comprising a second camera, having an overlapping field-of-view with said first camera; and
wherein said signal processor is further configured to combine image data from said first and second camera to identify additional object-related data for said object.

15. A touch sensitive image display device as claimed in claim 14 wherein said second camera is a visible light camera and wherein said additional object-related data comprises color data for said object.

16. A touch sensitive image display device as claimed in claim 14 for multi-touch detection of a plurality of objects part of or held by one or more people, and wherein said signal processor is configured to use said second camera to connect objects held by one person touching said touch sheet at different places.

17. A method of touch sensing in a touch sensitive image display device, the method comprising:
projecting a displayed image onto a surface;
projecting a light defining a touch sheet above said displayed image;
capturing a touch sense image from a region including at least a portion of said touch sheet, said touch sense image comprising light scattered from said touch sheet by an object approaching said displayed image; and
processing said touch sense image to identify a location of said object relative to said displayed image;
the method further comprising:
capturing a second, image from a region above said displayed image; and
using data from said second image to provide additional object-related data for said object.

18. A method of calibrating a system as claimed in claim 1, the method comprising:
projecting a calibration pattern;
capturing images from said touch sensing subsystem and said second object position sensing subsystem/camera; and
determining respective spatial distortion-correcting calibrations for said touch sensing subsystem and said second object position subsensing system/camera from the same said calibration pattern.

19. A method of capturing a user action in a system as claimed in claim 1, the method comprising:
identifying a first touch with a first object at a first location;
distinguishing a second touch with a second, different object at a second different location; and
determining a user action dependent on one or both of a distance and a direction of said second touch with reference to said first touch.

20. A physical, non-transitory data carrier carrying processor control code to implement the method of claim 17.
